(19) United States
(12) Patent Application Publication
(10) Pub. No.: US 2026/0148389 A1
(43) Pub. Date: May 28, 2026

(54) SYSTEMS AND METHODS FOR INLINE QUALITY CONTROL OF SLIDE DIGITIZATION

(71) Applicant: Pramana, Inc., Cambridge, MA (US)

(72) Inventors: Durgaprasad Dodle, Telangana (IN); Shilpa G. Krishna, Kerala (IN); Priyanka Golchha, Rajasthan (IN); Raghubansh Bahadur Gupta, Bangalore (IN); Jaya Jain, Shahpura (IN); Prasanth Perugupalli, Cary, NC (US); Prateek Jain, Karnataka (IN); Parveen Shaik Gangirevula, Bengaluru (IN); Pavani Pallavi Pelluru, Pocharam (IN)

(73) Assignee: Pramana, Inc., Cambridge, MA (US)

(21) Appl. No.: 19/449,642

(22) Filed: Jan. 15, 2026

Related U.S. Application Data
(63) Continuation-in-part of application No. 18/602,947, filed on Mar. 12, 2024, now Pat. No. 12,548,157.
(60) Provisional application No. 63/466,950, filed on May 16, 2023.

(51) Int. Cl. G06T 7/00; G06T 7/73

(52) U.S. Cl. CPC G06T 7/0014; G06T 7/74; G06T 2207/20212; G06T 2207/30024; G06T 2207/30168; G06T 2207/30204

(57) ABSTRACT

Described herein is a system for digitizing a slide. A system may include an optical system comprising at least an optical sensor and at least a processor communicatively connected to the optical system, wherein the at least a processor is configured to perform a scan of a slide by capturing at least a first image according to a first scanning parameter, determine, using a localization module, a localization quality metric as a function of the at least a first image, identify, using the localization module and the localization quality metric, at least one region of interest of the slide, determine a second scanning parameter as a function of the localization quality metric, capture, using the optical system, at least a second image of the slide according to the second scanning parameter, and generate a map comprising values associated with locations of the slide comprising a biological sample.

### CROSS-REFERENCE TO RELATED APPLICATIONS

This application is a continuation-in-part of U.S. Non-provisional patent application Ser. No. 18/602,947, filed on Mar. 12, 2024, and entitled “SYSTEMS AND METHODS FOR INLINE QUALITY CONTROL OF SLIDE DIGITIZATION,” which claims the benefit of priority of U.S. Provisional Patent Application Ser. No. 63/466,950, filed on May 16, 2023, and entitled “SYSTEMS AND METHODS FOR INLINE QUALITY CONTROL OF SLIDE DIGITIZATION,” both of which are incorporated by reference herein in their entirety.

### FIELD OF THE INVENTION

The present invention generally relates to the field of slide digitization. In particular, the present invention is directed to techniques for inline quality control of slide digitization.

### BACKGROUND

Examination of slides containing biomedical specimens, such as tissue samples, under a microscope provides data that can be exploited for a variety of biomedical applications. For example, physicians or other qualified individuals may be able to diagnose pathological conditions or detect microbial organisms. In many instances, the physician may observe the slides directly under the microscope. Increasingly, however, it is desirable to digitize microscope slides for downstream analysis.

### SUMMARY OF THE DISCLOSURE

In an aspect, a system for digitizing a slide may include an optical system comprising at least an optical sensor and at least a processor communicatively connected to the optical system, wherein the at least a processor is configured to perform a scan of a slide by capturing at least a first image according to a first scanning parameter, determine, using a localization module, a localization quality metric as a function of the at least a first image, identify, using the localization module and the localization quality metric, at least one region of interest of the slide, determine a second scanning parameter as a function of the localization quality metric, capture, using the optical system, at least a second image of the slide according to the second scanning parameter, and generate, as a function of the localization quality metric and the at least a second image, a map comprising values associated with locations of the slide comprising a biological sample.

In another aspect, a method of digitizing a slide may include, using at least a processor, performing, using an optical system comprising at least an optical sensor, a scan of a slide by capturing a first image according to a first scanning parameter, determining, using a localization module, a localization quality metric as a function of the first image, identifying, using the localization module and the localization quality metric, at least one region of interest of the slide, determining, using at least a processor communicatively connected to the optical system, a second scanning parameter as a function of the localization quality metric, capturing, using the optical system, at least a second image of the slide according to the second scanning parameter, and generating, as a function of the localization quality metric and the at least a second image, a map comprising values associated with locations of the slide comprising a biological sample.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram of an exemplary embodiment of a system for inline quality control of slide digitization;

FIG. 2 is a flow diagram of an exemplary embodiment of a data flow for inline quality control;

FIGS. 3A-3B are diagrams of an exemplary embodiment of a localization module of a data flow for inline quality control;

FIG. 4 is a diagram of an exemplary embodiment of a biopsy plane estimation module of a data flow for inline quality control;

FIG. 5 is a diagram of an exemplary embodiment of a focus sampling module of a data flow for inline quality control;

FIGS. 6A-6B are diagrams of an exemplary embodiment of a z-stack acquisition module of a data flow for inline quality control;

FIGS. 7A-7B are diagrams of an exemplary embodiment of a stitching module of a data flow for inline quality control;

FIG. 8 is a flow diagram of an exemplary embodiment of a method for inline quality control of slide digitization;

FIG. 9 is a diagram depicting an exemplary embodiment of a system for digitizing a slide;

FIG. 10 is a block diagram of an exemplary system for digitizing a slide;

FIG. 11 is a box diagram of an exemplary machine learning model;

FIG. 12 is a diagram of an exemplary neural network;

FIG. 13 is a diagram of an exemplary neural network node;

FIG. 14 is a flow diagram depicting an exemplary embodiment of a method of digitizing a slide; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Over the last several years, an increasing amount of clinical patient data has become digitized, and progress has been made in building systems that process clinical patient data in an electronic format. For example, cloud-based systems can collect digitized health records from across institutions (e.g., hospitals, clinics, etc.) and can analyze patient data at a scale that was not attainable until recently. For example, de-identification of electronic health records has opened up the possibility of learning from de-identified data within and across medical institutions/facilities that are owners of the de-identified data. Variations of federated learning approaches are now being used to facilitate such learning within and across data repositories.

As the amount of data and processing scale increases, there is an emerging need for techniques that can automate the process of acquiring clinically relevant digital data. Digitized slides, such as whole slide images (WSIs), are one such type of digital data. Clinical and research institutions use slides containing biomedical specimens (e.g., tissue samples) for a wide range of applications such as disease diagnosis. The ability to digitize slides at scale may facilitate a variety of downstream applications such as training machine learning models and performing large-scale data analysis.

However, this approach to slide digitization may be manually intensive, involving intervention by a clinician at various steps of the digitization process. Moreover, this approach may be error-prone or inefficient. For example, as further explained below, portions of the output image may be out of focus and may contain unwanted artifacts, such as ghosting and banding. As another example, the specimen of interest may be missing from the portion of the slide that is scanned.

To prevent such digitization errors from interfering with downstream applications, it may be possible to perform a post-imaging quality check to determine whether a slide image meets a given acceptance criteria. However, post-imaging quality checks offer limited remedial options. For example, one remedial option may be to remove an image of a slide that does not meet the acceptance criteria from the data set, but this undesirably results in a smaller set of data for downstream applications, and the resources that were used to prepare and scan the slide would be wasted. Another remedial option may be to rescan a slide that does not meet the acceptance criteria, but this approach may be inefficient—e.g., this approach may involve rescanning an entire slide even when the error impacts a portion of the slide, the slide may have already been physically removed from the scanner or placed into storage, or the like. These inefficiencies may result in wasted resources, delayed diagnoses, increased manual intervention in the digitization process, low throughput, or the like. For example, a given slide may undergo multiple passes through the scanner before an image that passes the quality checks is produced, resulting in additional time consumption to set up and wind down each pass through the scanner. Ultimately, digitization errors may have the effect of significantly reducing the scanning throughput and thereby limiting the scalability of the slide digitization process.

Therefore, an opportunity exists for slide digitization with inline quality controls—e.g., quality controls that are performed concurrently with the steps of the slide digitization process and/or prior to removing the slide from the scanner. Inline quality controls may facilitate increased automation, quality, and throughput in the slide digitization process while mitigating the downsides associated with inadequate quality control, e.g., the post-imaging quality control described above. For example, inline quality controls may facilitate throughput-enhancing remedial options, such as rescanning selected portions of a slide determined to be defective (rather than an entire slide) and initiating rescans prior to a slide being removed from the scanner. Illustratively, inline quality controls may enable scanning a slide, performing quality checks, and rescanning areas identified as defective in a single pass through the scanner, which in turn increases the throughput of high-quality scanned images. In some embodiments, a system and/or method described herein may be used for high volume scanning.

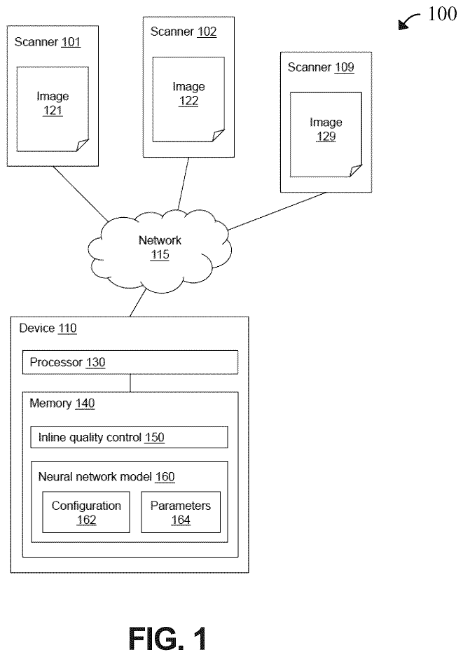

FIG. 1 is a simplified diagram of a system 100 for inline quality control of slide digitization according to some embodiments. System 100 may include a processor. Processor may include, without limitation, any processor described in this disclosure. Processor may be included in a computing device. System 100 may include at least a processor and a memory communicatively connected to the at least a processor, the memory containing instructions configuring the at least a processor to perform one or more processes described herein. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

Still referring to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, as used in this disclosure, “communicatively connected” means connected by way of a connection, attachment or linkage between two or more relata which may allow for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, in some embodiments, system 100 may be used to generate an image of slide and/or a sample on slide. As used herein, a “slide” is a container or surface holding a sample of interest. In some embodiments, slide may include a glass slide. In some embodiments, slide may include a formalin fixed paraffin embedded slide. In some embodiments, a sample on slide may be stained. In some embodiments, slide may be substantially transparent. In some embodiments, slide may include a thin, flat, and substantially transparent glass slide. In some embodiments, a transparent cover may be applied to slide such that a sample is between slide and this cover. A sample may include, in non-limiting examples, a blood smear, pap smear, body fluids, and non-biologic samples. In some embodiments, a sample on slide may include tissue. In some embodiments, sample on slide may be frozen.

Still referring to FIG. 1, in some embodiments, slide and/or a sample on slide may be illuminated. In some embodiments, system 100 may include a light source. As used herein, a “light source” is any device configured to emit electromagnetic radiation. In some embodiments, light source may emit a light having substantially one wavelength. In some embodiments, light source may emit a light having a wavelength range. Light source may emit, without limitation, ultraviolet light, visible light, and/or infrared light. In non-limiting examples, light source may include a light-emitting diode (LED), an organic LED (OLED) and/or any other light emitter. Such a light source may be configured to illuminate slide and/or sample on slide. In a non-limiting example, light source may illuminate slide and/or sample on slide from below.

Still referring to FIG. 1, in some embodiments, system 100 may include at least an optical system. As used in this disclosure, an “optical system” is an arrangement of one or more components which together act upon or employ electromagnetic radiation. In non-limiting examples, electromagnetic radiation may include light, such as visible light, infrared light, UV light, and the like. An optical system may include one or more optical elements, including without limitation lenses, mirrors, windows, filters, and the like. An optical system may form an optical image that corresponds to an optical object. For instance, an optical system may form an optical image at or upon an optical sensor, which can capture, e.g., digitize, the optical image. In some cases, optical system may have at least a magnification. For instance, optical system may include an objective (e.g., microscope objective) and one or more reimaging optical elements that together produce an optical magnification. In some cases, optical magnification may be referred to herein as zoom. As used herein, an “optical sensor” is a device that measures light and converts the measured light into one or more signals. In an embodiment, the one or more signals may include, without limitation, one or more electrical signals. In some embodiments, optical sensor may include at least a photodetector. As used herein, a “photodetector” is a device that is sensitive to light and thereby able to detect light. In some embodiments, a photodetector may include a photodiode, a photoresistor, a photosensor, a photovoltaic chip, and the like. In some embodiments, optical sensor may include a plurality of photodetectors. Optical sensor may include, without limitation, a camera. Optical sensor may be in electronic communication with at least a processor of system 100. As used herein, “electronic communication” as used in this disclosure is a shared data connection between two or more devices. In some embodiments, system 100 may include two or more optical sensors. In some embodiments, a scanner may include at least an optical system. For example, scanner 101, scanner 102, and/or scanner 109 may include at least an optical system.

Still referring to FIG. 1, in some embodiments, optical system may include a camera. In some cases, a camera may include one or more optics. Exemplary non-limiting optics include spherical lenses, aspherical lenses, reflectors, polarizers, filters, windows, aperture stops, and the like. In some embodiments, one or more optics associated with a camera may be adjusted in order to, in non-limiting examples, change the zoom, depth of field, and/or focus distance of the camera. In some embodiments, one or more of such settings may be configured to detect a feature of a sample on slide. In some embodiments, one or more of such settings may be configured based on a scanning parameter, as described herein. In some embodiments, camera may capture images at a low depth of field. In a non-limiting example, camera may capture images such that a first depth of sample is in focus and a second depth of sample is out of focus. In some embodiments, an autofocus mechanism may be used to determine focus distance. In some embodiments, focus distance may be set by parameter set. In some embodiments, camera may be configured to capture a plurality of images at different focus distances. In a non-limiting example, camera may capture a plurality of images at different focus distances, such that images are captured where each focus depth of the sample is in focus in at least one image. In some embodiments, at least a camera may include an image sensor. Exemplary non-limiting image sensors include digital image sensors, such as without limitation charge-coupled device (CCD) sensors and complimentary metal-oxide-semiconductor (CMOS) sensors. In some embodiments, a camera may be sensitive within a non-visible range of electromagnetic radiation, such as without limitation infrared.

Still referring to FIG. 1, as used herein, “image data” is information representing at least a physical scene, space, and/or object. Image data may include, for example, information representing a sample, slide, or region of a sample or slide. In some cases, image data may be generated by a camera. “Image data” may be used interchangeably through this disclosure with “image,” where image is used as a noun. An image may be optical, such as without limitation where at least an optic is used to generate an image of an object. An image may be digital, such as without limitation when represented as a bitmap. Alternatively, an image may include any media capable of representing a physical scene, space, and/or object. Alternatively, where “image” is used as a verb, in this disclosure, it refers to generation and/or formation of an image.

Still referring to FIG. 1, in some embodiments, system 100 may include a slide port. In some embodiments, slide port may be configured to hold slide. In some embodiments, slide port may include one or more alignment features. As used herein, an “alignment feature” is a physical feature that helps to secure a slide in place and/or align a slide with another component of an apparatus. In some embodiments, alignment feature may include a component which keeps slide secure, such as a clamp, latch, clip, recessed area, or another fastener. In some embodiments, slide port may allow for easy removal or insertion of slide. In some embodiments, slide port may include a transparent surface through which light may travel. In some embodiments, slide may rest on and/or may be illuminated by light traveling through such a transparent surface. In some embodiments, slide port may be mechanically connected to an actuator mechanism as described below. In some embodiments, a scanner may include a slide port. For example, scanner 101, scanner 102, and/or scanner 109 may include a slide port.

Still referring to FIG. 1, in some embodiments, system 100 may include an actuator mechanism. As used herein, an “actuator mechanism” is a mechanical component configured to change the relative position of a slide and an optical system. In some embodiments, actuator mechanism may be mechanically connected to slide, such as slide in slide port. In some embodiments, actuator mechanism may be mechanically connected to slide port. For example, actuator mechanism may move slide port in order to move slide. In some embodiments, actuator mechanism may be mechanically connected to at least an optical system. In some embodiments, actuator mechanism may be mechanically connected to a mobile element. A mobile element may include a movable or portable object, component, and/or device within system 100 such as, without limitation, a slide, a slide port, or an optical system. In some embodiments, a mobile element may move such that optical system is positioned correctly with respect to slide such that optical system may capture an image of slide according to a scanning parameter. In some embodiments, actuator mechanism may be mechanically connected to an item selected from the list consisting of slide port, slide, and at least an optical system. In some embodiments, actuator mechanism may be configured to change the relative position of slide and optical system by moving slide port, slide, and/or optical system. In some embodiments, a scanner may include an actuator mechanism. For example, scanner 101, scanner 102, and/or scanner 109 may include an actuator mechanism.

Still referring to FIG. 1, actuator mechanism may include a component of a machine that is responsible for moving and/or controlling a mechanism or system. Actuator mechanism may, in some embodiments, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some embodiments, upon receiving a control signal, actuator mechanism responds by converting source power into mechanical motion. In some cases, actuator mechanism may be understood as a form of automation or automatic control.

Still referring to FIG. 1, in some embodiments, actuator mechanism may include a hydraulic actuator. A hydraulic actuator may consist of a cylinder or fluid motor that uses hydraulic power to facilitate mechanical operation. Output of hydraulic actuator mechanism may include mechanical motion, such as without limitation linear, rotatory, or oscillatory motion. In some embodiments, hydraulic actuator may employ a liquid hydraulic fluid. As liquids, in some cases, are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. Single acting may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. Double acting may be used when pressure is applied substantially on each side of a piston; any difference in resultant force between the two sides of the piston causes the piston to move.

Still referring to FIG. 1, in some embodiments, actuator mechanism may include a pneumatic actuator mechanism. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible fluid (e.g., air). In some cases, a pneumatic actuator may operate on compressed air. Operation of hydraulic and/or pneumatic actuators may include control of one or more valves, circuits, fluid pumps, and/or fluid manifolds.

Still referring to FIG. 1, in some cases, actuator mechanism may include an electric actuator. Electric actuator mechanism may include any of electromechanical actuators, linear motors, and the like. In some cases, actuator mechanism may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. Electric actuator mechanism may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may be directly controlled by a control signal for controlling one or more linear motor parameters. Exemplary linear motor parameters include without limitation position, force, velocity, potential, and current.

Still referring to FIG. 1, in some embodiments, an actuator mechanism may include a mechanical actuator mechanism. In some cases, a mechanical actuator mechanism may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanisms, including for example without limitation gears, rails, pulleys, cables, linkages, and the like.

Still referring to FIG. 1, in some embodiments, actuator mechanism may be in electronic communication with actuator controls. As used herein, “actuator controls” is a system configured to operate actuator mechanism such that a slide and an optical system reach a desired relative position. In some embodiments, actuator controls may operate actuator mechanism based on input received from a user interface. In some embodiments, actuator controls may be configured to operate actuator mechanism such that optical system is in a position to capture an image of an entire sample. In some embodiments, actuator controls may be configured to operate actuator mechanism such that optical system is in a position to capture an image using settings of a particular scanning parameter. In some embodiments, actuator controls may be configured to operate actuator mechanism such that optical system is in a position to capture an image of a region of interest, a particular horizontal row, a particular point, a particular focus depth, and the like. Electronic communication between actuator mechanism and actuator controls may include transmission of signals. For example, actuator controls may generate physical movements of actuator mechanism in response to an input signal. In some embodiments, input signal may be received by actuator controls from processor or input interface.

Still referring to FIG. 1, in some embodiments, system 100 may include a user interface. User interface may include output interface and input interface. In some embodiments, output interface may include one or more elements through which system 100 may communicate information to a user. In a non-limiting example, output interface may include a display. A display may include a high resolution display. A display may output images, videos, and the like to a user. In another non-limiting example, output interface may include a speaker. A speaker may output audio to a user. In another non-limiting example, output interface may include a haptic device. A haptic device may output haptic feedback to a user.

Still referring to FIG. 1, in some embodiments, input interface may include controls for operating system 100. Such controls may be operated by a user. Input interface may include, in non-limiting examples, a camera, microphone, keyboard, touch screen, mouse, joystick, foot pedal, button, dial, and the like. Input interface may accept, in non-limiting examples, mechanical input, audio input, visual input, text input, and the like. In some embodiments, input interface may approximate controls of a microscope.

Still referring to FIG. 1, system 100 may perform inline quality control of slide digitization. In a non-limiting embodiment, system 100 may include one or more scanners 101-109 that are communicatively coupled to a device 110. Scanners 101-109 generally include devices or systems used to digitize slides containing biomedical specimens (e.g., tissue samples), such as digital cameras, digital microscopes, digital pathology scanners, or the like. Device 110 generally includes a computing device or system, such as personal computer, an on-premises server, a cloud-based server, or the like. In some embodiments, device 110 may be directly connected to and/or integrated within one or more of scanners 101-109. Additionally, or alternately, scanners 101-109 may be communicatively coupled to device 110 via a network 115. Network 115 can include one or more local area networks (LANs), wide area networks (WANs), wired networks, wireless networks, the Internet, or the like. Illustratively, scanners 101-109 may communicate with device 110 over network 115 using the TCP/IP protocol or other suitable networking protocols. During operation, scanners 101-109 capture digital images 121-129 of the slides and send them to device 110, e.g., via network 115. For efficient storage and/or transmission, images 121-129 may be compressed prior to or during transmission. Security measures such as encryption, authentication (including multi-factor authentication), SSL, HTTPS, and other security techniques may also be applied.

Still referring to FIG. 1, in some embodiments, device 110 may be configured to control the operation of scanners 101-109 to automate the slide digitization process. For example, device 110 may send instructions to scanners 101-109 to scan or rescan selected portions of a slide (e.g., areas identified by x-, y-, and/or z-coordinates or bounding boxes). Device 110 may further select parameters associated with scanners 101-109, such as magnification level, focus settings, scanning pattern, or the like.

Still referring to FIG. 1, as discussed above, automating the slide digitization process using device 110 may present challenges. For example, one or more of images 121-129 may be out of focus or may capture a different portion of the slide than intended, e.g., the actual coordinates of the image may be offset from the intended coordinates. In embodiments where a series of images of a given slide are captured (e.g., when the slide is scanned using a grid scanning pattern), the process of stitching the images together to generate an aggregated image of the slide may introduce artifacts, such as ghosting or banding. These defects may interfere with downstream applications that receive the digitized slide images output by device 110. For example, the defects may result in a reduction in performance of a machine learning model trained using the digitized slides due to the reduced size and/or quality of the training data set. Moreover, the defects may be identified too late to efficiently take remedial action, e.g., a defective image may be removed from the data set (resulting in wasted resources that went into scanning the image), or the slide may be placed back into the scanner for another scanning pass (resulting in additional setup and takedown time). Such remedial actions may involve manual intervention, such that the level of automation in the slide digitization process is reduced.

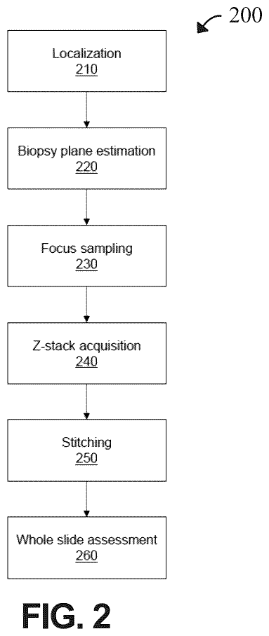

Still referring to FIG. 1, therefore, according to some embodiments, device 110 includes an inline quality control program 150, which may address one or more of the challenges identified above. Namely, as depicted in FIG. 1, device 110 includes a processor 130 (e.g., one or more hardware processors) coupled to a memory 140 (e.g., one or more non-transitory memories). Memory 140 stores instructions and/or data corresponding to inline quality control program 150. When executed by processor 130, inline quality control program 150 causes processor 130 to perform operations associated with inline quality control of slide digitization based on images 121-129. Illustrative embodiments of data flows implemented by inline quality control program 150 are described in further detail below with reference to FIG. 2.

Still referring to FIG. 1, during execution of inline quality control program 150, processor 130 may execute one or more neural network models, such as neural network model 160. Neural network model 160 is trained to make predictions (e.g., inferences) based on input data. Neural network model 160 includes a configuration 162, which defines a plurality of layers of neural network model 160 and the relationships among the layers. Illustrative examples of layers include input layers, output layers, convolutional layers, densely connected layers, merge layers, and the like. In some embodiments, neural network model 160 may be configured as a deep neural network with at least one hidden layer between the input and output layers. Connections between layers can include feed-forward connections or recurrent connections.

Still referring to FIG. 1, one or more layers of neural network model 160 is associated with trained model parameters 164. The trained model parameters 164 include a set of parameters (e.g., weight and bias parameters of artificial neurons) that are learned according to a machine learning process. During the machine learning process, labeled training data is provided as an input to neural network model 160, and the values of trained model parameters 164 are iteratively adjusted until the predictions generated by neural network model 160 match the corresponding labels with a desired level of accuracy.

Still referring to FIG. 1, for improved performance, processor 130 may execute neural network model 160 using a graphical processing unit, a tensor processing unit, an application-specific integrated circuit, or the like.

With continued reference to FIG. 1, in an embodiment, the system 100 may detect a slide-quality control error and may generate automated alerts that prompt an operator to undertake remedial actions aimed at preserving image quality and diagnostic reliability. As used in this disclosure, a “slide-quality control error” is a condition in which one or more characteristics of a microscope slide or its associated image fail to satisfy predetermined quality criteria, such that downstream analytical or diagnostic processes may suffer reduced accuracy, reliability, or interpretability. In a non-limiting example, a slide-quality control error may include the presence of imaging artifacts such as glare, dust, bubbles, or debris that obscure tissue features and may interfere with downstream analysis. In a non-limiting example, a slide-quality control error may arise when system 100 detects improper focus, insufficient resolution, or incomplete coverage of the tissue region, any of which may degrade the fidelity of acquired image data. In a non-limiting example, a slide-quality control error may involve staining irregularities, tissue folds, or mounting defects that alter the visual appearance of structures of interest and may prevent accurate interpretation by automated or human review. As used in this disclosure, an “automated alert” is a system-generated notification produced in response to detecting a condition requiring user awareness or intervention. In an embodiment, the condition may include a slide-quality control error or an operational state that may impact imaging performance. In a non-limiting example, an automated alert may notify the operator that system 100 detected an out-of-focus region and may prompt the operator to initiate a targeted reacquisition. In a non-limiting example, an automated alert may indicate the presence of artifacts, dust, or staining anomalies and may suggest that the operator review remediation options before proceeding. In a non-limiting example, an automated alert may warn that system 100 identified incomplete tissue coverage, mechanical obstruction, or scanner instability and may guide the operator through corrective steps to maintain imaging quality. System 100 may rescan all or selected portions of the slide. System 100 may apply computational techniques to address image defects. System 100 may generate visual indicators of defect locations for downstream review. In an embodiment, system 100 may initiate the remedial workflow before the operator removes the slide from the scanner, thereby reducing handling time and minimizing manual intervention.

With continued reference to FIG. 1, in a non-limiting example, system 100 may perform preparation-stage or acquisition-stage quality control assessments that identify artifacts, improper focus, staining irregularities, or other conditions that could compromise downstream analysis. As used in this disclosure, a “preparation-stage quality control assessment” is an evaluation that system 100 performs before image acquisition to determine whether a slide, a mounted tissue sample, or associated scanner conditions satisfy predefined quality criteria that support reliable imaging. As used in this disclosure, an “acquisition-stage quality control assessment” is an evaluation that system 100 performs during image capture to determine whether acquired image data meet predefined quality thresholds. Without limitation, the image data and the predefined quality thresholds may relate to focus, illumination, coverage, resolution, or artifact levels. When system 100 detects such conditions, it may notify the operator and may enable responsive corrective measures while the slide remains mounted. System 100 may allow the operator to select from multiple automated or semi-automated remediation pathways, including applying image-processing algorithms, invoking inpainting routines powered by generative models, or selectively reacquiring deficient image regions. In a non-limiting example, system 100 may perform diverse remedial operations while the slide remains positioned within the scanner. System 100 may rely on digital correction, selective reacquisition, and workflow adjustments that operate without removing and remounting the slide.

With continued reference to FIG. 1, in a non-limiting example, system 100 may perform a pre-scan determination that a slide cannot be scanned when the system evaluates macro-level imagery and identifies defects that would prevent successful high-magnification image acquisition. During this stage, system 100 may review the slide before beginning the full-resolution scan and assesses whether the slide exhibits conditions such as broken glass, extreme tissue folds, missing or insufficient tissue, obscuring debris, or other preparation defects that fundamentally compromise the ability to generate usable image data. In a non-limiting example, the pre-scan determination process may rely on low-magnification or macro imaging performed prior to initiating the main scanning sequence. System 100 may capture an overview image of the entire slide and analyze that image to detect issues that are too severe to be corrected by digital methods or selective reacquisition. Without limitation, by identifying these issues in advance, system 100 may prevent wasted scan time, avoid unnecessary operator intervention later in the workflow, and maintain efficient use of imaging resources. In a non-limiting example, the localization module may operate as the component within system 100 that analyzes the macro image and determines whether the slide is suitable for scanning. The localization module may evaluate the spatial distribution of tissue, identify obstructive artifacts, or detect major structural defects that would propagate into downstream image data. When the localization module concludes that the defects cannot be resolved through on-scanner remediation, it may direct system 100 to halt progression into the high-magnification imaging stage and issue an automated alert advising the operator that the slide cannot be scanned.

With continued reference to FIG. 1, in a non-limiting example, system 100 may incorporate a domain specific classifier that distinguishes preparation-domain defects from scanning-domain defects to determine the appropriate remediation workflow and to ensure that the operator receives accurate, context-specific guidance. As used in this disclosure, “preparation-domain defects” are defects that originate from slide preparation. In an embodiment, slide preparation may include mounting, staining, and/or handling before the slide enters system 100. Without limitation, the preparation-domain defects may reflect physical or structural conditions inherent to the slide itself. Such defects arise independently of the scanning process and affect the slide prior to any interaction with the imaging hardware. As used in this disclosure, “scanning-domain defects” are defects that originate from the imaging process performed by system 100. In an embodiment, the scanning-domain defects may reflect conditions or events occurring during optical acquisition, stage movement, illumination control, or other scan-time operations. In an embodiment, the scanning-domain defects may arise from the interaction between the slide and the imaging components while system 100 captures image data. In a non-limiting example, scanning-domain defects may arise when system 100 encounters a focus failure caused by rapid changes in tissue height during image acquisition, leading to blurred regions that require selective reacquisition. In a non-limiting example, scanning-domain defects may occur when illumination becomes unstable during the scan, producing brightness banding or contrast inconsistencies that degrade downstream analysis. In a non-limiting example, scanning-domain defects may appear when the stage drifts or vibrates while system 100 captures the image, resulting in motion-induced artifacts that reflect the dynamic interaction between the slide and the imaging components. Without limitation, the classifier may analyze features extracted from macro images, low-magnification imagery, or early scan data and assign the detected issue to the domain most consistent with the underlying cause. This separation may enable system 100 to decide whether digital correction, selective reacquisition, or a halt-and-alert workflow best addresses the identified defect. In a non-limiting example, a preparation-domain defect classifier may focus on conditions originating before the slide enters system 100, such as debris on the slide, mounting irregularities, tissue folds, tissue absence, broken glass, or staining anomalies. When the classifier assigns a defect to this domain, system 100 may determine that the issue cannot be corrected through scanning operations and may alert the operator accordingly. This classification pathway may help system 100 avoid unnecessary scan attempts and ensures that defects traceable to slide preparation receive the appropriate off-scanner remediation. In a non-limiting example, a scanning-domain defect classifier may evaluate issues arising during image acquisition, such as focus failures, illumination inconsistencies, incomplete coverage due to stage motion, or transient artifacts introduced by the scanning process. When the classifier assigns a defect to this domain, system 100 may initiate actions such as selective reacquisition, illumination adjustment, or other workflow corrections that operate without removing and remounting the slide. This classification pathway may allow system 100 to remediate dynamic scanning errors efficiently while preserving imaging continuity. In a non-limiting example, system 100 may train the classifier using supervised machine learning techniques in which the model learns to distinguish preparation-domain defects from scanning-domain defects based on labeled examples. The classifier may include models such as convolutional neural networks, transformer-based vision architectures, gradient-boosted decision trees, linear classifiers, or hybrid ensembles that combine image-based and metadata-based features. The training process may involve exposing the model to large sets of annotated slide images that contain known defect types, along with corresponding domain labels that specify whether each defect originated from slide preparation or from scan-time processes. In a non-limiting example, the training data may include macro images, low-magnification images, and high-magnification scan fragments that capture a diverse range of defect signatures. The dataset may incorporate examples of dust, debris, tissue folds, staining irregularities, tissue absence, and mounting anomalies to represent preparation-domain defects. It may also incorporate focus failures, illumination fluctuations, banding artifacts, motion-induced distortions, and incomplete coverage to represent scanning-domain defects. The inclusion of both raw imagery and derived feature maps may allow the classifier to learn nuanced distinctions between defect origins. In a non-limiting example, system 100 may augment the training dataset by applying synthetic transformations that simulate realistic variations in defect appearance. These transformations may include perturbing illumination, altering focus, introducing artificial motion artifacts, or overlaying debris-like structures. Such augmentation may improve model robustness and enable the classifier to generalize across different scanners, slide types, tissue preparations, and imaging conditions. System 100 may validate and refine the classifier using held-out datasets, cross-validation procedures, active-learning loops, and the like in which uncertain predictions are flagged for human review to strengthen future training cycles.

With continued reference to FIG. 1, in a non-limiting example, system 100 may be configured to detect tissue located outside the coverslip area, which may constitute a preparation-domain defect that can compromise scanning performance and downstream analysis. As used in this disclosure, a “coverslip” is a sheet placed over a mounted tissue specimen on a microscope slide. Without limitation, the coverslip may be used to protect the sample, maintain a uniform optical surface, create a stable interface for high-quality imaging, and the like. Without limitation, the coverslip may be a thin and transparent sheet. In an embodiment, when tissue extends beyond the protected region of the slide, it may interfere with the scanner's optical path, introduce unexpected height variations, or cause focus instability during image acquisition. To address this, system 100 may analyze macro-level or low-magnification images to identify tissue regions that fall outside the expected coverslip boundaries, using geometric models, edge-detection algorithms, or learned segmentation networks to delineate the coverslip perimeter and compare it against the spatial distribution of tissue. In a non-limiting example, once system 100 detects tissue located outside the coverslip, the system may classify the condition as a preparation-domain defect and may initiate an appropriate response, such as generating an automated alert or halting the scan before high-magnification imaging begins. This proactive detection may prevent the scanner from encountering mechanical interference or from acquiring unusable image data due to tissue height irregularities beyond the coverslip. Without limitation, by integrating tissue-outside-coverslip detection into the pre-scan evaluation workflow, system 100 may enhance reliability, reduce operator burden, and maintain imaging quality across diverse slide preparations.

With continued reference to FIG. 1, in a non-limiting example, system 100 may be configured to detect tissue folds as slide defects that arise during the preparation and mounting of the sample. As used in this disclosure, “tissue folds” are physical deformations in a mounted biological specimen. In an embodiment, tissue folds may include physical deformations in which portions of the tissue overlap, crease, or buckle, creating discontinuities in surface topology that disrupt uniform imaging and impair optical quality during scanning. Without limitation, tissue folds may alter the physical topology of the specimen, creating abrupt height variations and distortions that interfere with focus stability, introduce shadowing or optical aberrations, disrupt uniform imaging across the slide, and the like. To identify such defects, system 100 may analyze macro-level images, low-magnification scans, or early high-magnification frames to locate regions where the tissue surface exhibits sharp discontinuities, overlapping layers, or characteristic fold textures. System 100 may employ image-processing filters, morphological feature extractors, or learned representations generated by neural networks to distinguish true folds from normal tissue structures. In a non-limiting example, once system 100 detects tissue folds, the system may classify the condition as a preparation-domain defect and may determine whether the folds prohibit reliable scanning or whether partial remediation, such as adaptive focus strategies or selective reacquisition, remains feasible. When the folds exceed correctable thresholds, system 100 may halt the scan and generate an automated alert that advises the operator of the defect before additional imaging proceeds. Without limitation, by incorporating tissue-fold detection into its quality control workflow, system 100 may prevent wasted scan time, reduce operator burden, and ensure that downstream analytical processes receive image data of sufficient fidelity.

With continued reference to FIG. 1, in a non-limiting example, system 100 may be configured to detect air bubbles as slide defects that originate during mounting of the tissue specimen beneath the coverslip. Without limitation, air bubbles may create localized regions where the refractive index abruptly changes, producing bright halos, shadows, or distortions in the resulting images. Such artifacts may obscure key morphological features, interfere with automated analysis algorithms, or cause repeated focus failures during scanning. To identify these defects, system 100 may analyze macro images, low-magnification scans, or early high-resolution frames using contrast-based filters, blob-detection algorithms, or learned classifiers that recognize the characteristic circular or irregular optical patterns associated with trapped air. In a non-limiting example, once system 100 detects an air bubble, the system 100 may classify the condition as a preparation-domain defect and may determine how the bubble's size, location, and proximity to critical tissue regions influence the feasibility of scanning. If the air bubble resides in an area that would prevent accurate imaging, system 100 may halt the scan and generate an automated alert indicating that the slide requires remediation. If the bubble affects only a small, non-critical region, system 100 may proceed with selective reacquisition or adapted imaging strategies for unaffected areas. Without limitation, by incorporating air-bubble detection into its quality-control workflow, system 100 may maintain imaging reliability and avoid propagation of artifacts into downstream diagnostic or analytical processes.

With continued reference to FIG. 1, in a non-limiting example, system 100 may be configured to detect pen marks or other manually added annotations on the slide as preparation-domain defects that interfere with imaging quality. Without limitation, such markings, often made on the glass surface during laboratory handling, create high-contrast lines or filled regions that do not correspond to tissue structures and can obstruct portions of the optical path. When illuminated during scanning, these marks may produce glare, diffraction patterns, or shadowing artifacts that degrade the clarity and interpretability of captured images. To identify these defects, system 100 may analyze macro-level images or low-magnification scans using edge-detection filters, color-segmentation methods, learned models that discriminate between tissue features and foreign markings applied to the slide, and the like. In a non-limiting example, once system 100 detects a pen mark or annotation, the system may classify the condition as a preparation-domain defect and may determine how its size, location, and optical impact affect the scan's viability. For markings that obstruct critical tissue regions, system 100 may generate an automated alert indicating that the slide requires remediation before imaging can proceed. For markings located outside tissue-bearing areas, system 100 may continue with the scan while applying appropriate masking or correction routines to mitigate visual interference. Without limitation, by integrating pen-mark and annotation detection into its quality-control workflow, system 100 may ensure that imaging data remain free from extraneous artifacts and suitable for downstream diagnostic or analytical applications.

With continued reference to FIG. 1, in a non-limiting example, system 100 may be configured to detect uneven staining as a slide defect that originates during tissue processing and preparation. Uneven staining may manifest when dyes or reagents bind inconsistently across the tissue, producing regions that appear overly dark, overly pale, or irregular in color balance relative to the rest of the specimen. Such inconsistencies can obscure cellular detail, distort morphological interpretation, and interfere with downstream computational analyses that rely on consistent color profiles. To identify uneven staining, system 100 may analyze macro-level imagery, low-magnification scans, or early high-resolution frames using color-histogram analysis, spatial variance measurements, stain-normalization metrics, or machine learning models trained to recognize staining irregularities across diverse tissue types and protocols. In a non-limiting example, once system 100 detects uneven staining, the system may classify the condition as a preparation-domain defect and may determine the extent to which the irregularity affects diagnostic utility or downstream analytical processes. If the uneven staining severely degrades visual fidelity or renders critical structures indiscernible, system 100 may generate an automated alert indicating that the slide requires remediation or restaining before scanning can proceed. If the irregularity is localized or mild, system 100 may employ digital correction techniques, such as stain normalization, color-balancing routines, or adaptive illumination adjustments, to partially mitigate the defect while continuing the imaging sequence. Without limitation, by incorporating uneven-staining detection into its quality-control workflow, system 100 may enhance consistency, reduce diagnostic ambiguity, and ensure high-quality image data for subsequent review.

With continued reference to FIG. 1, in a non-limiting example, system 100 may be configured to distinguish preparation defects from scanner acquisition defects to ensure that the system applies the correct remediation workflow and avoids unnecessary or ineffective corrective actions. Preparation defects may arise from issues intrinsic to the slide before it enters system 100 such as debris, tissue folds, uneven staining, tissue outside the coverslip, pen marks, air bubbles, or mounting anomalies, none of which system 100 can remediate through imaging adjustments alone. Scanner acquisition defects may arise from conditions occurring during the imaging process such as transient focus failures, illumination fluctuations, incomplete coverage, or motion artifacts, many of which system 100 can correct through selective reacquisition, parameter adjustments, or digital correction. To perform this discrimination, system 100 may analyze spatial patterns, temporal signatures, and defect morphologies using feature extractors, rule-based logic, machine learning models trained to differentiate between intrinsic slide defects and dynamic scan-time anomalies, and the like. In a non-limiting example, once system 100 classifies a detected issue as either a preparation defect or a scanner acquisition defect, the system may initiate the appropriate response pathway. When system 100 identifies a scanner acquisition defect, the system 100 may attempt corrective actions such as adjusting focus, modifying illumination, stabilizing stage motion, or reacquiring image regions affected by the error. When system 100 identifies a preparation defect, the system may determine that the issue cannot be corrected through scanning operations and may generate an automated alert instructing the operator that remediation requires off-scanner intervention such as slide cleaning, remounting, or restaining. Without limitation, by distinguishing between correctable scanner errors and uncorrectable slide errors, system 100 may reduce wasted scan time, increase imaging reliability, and enable efficient and defect-appropriate responses throughout the imaging workflow.

With continued reference to FIG. 1, in a non-limiting example, system 100 may be configured to perform pre-scan quality control for slide preparation defects by evaluating the slide before initiating high-magnification imaging. During this stage, system 100 may acquire macro or low-magnification overview images and analyze them to determine whether the slide exhibits physical or structural issues introduced during preparation. These issues may include debris on the slide surface, tissue folds, air bubbles, pen marks, uneven staining, tissue outside the coverslip region, or mounting anomalies that alter the optical profile of the slide. Without limitation, by conducting this assessment before scanning begins, system 100 may prevent unnecessary imaging attempts that would otherwise lead to unreliable data or repeated scan failures. In a non-limiting example, once system 100 completes the pre-scan quality control evaluation, the system may determine whether any detected preparation defects prevent the slide from being scanned reliably. When the system identifies a defect that compromises image acquisition, system 100 may halt the workflow and generate an automated alert instructing the operator to remediate the issue off-scanner. When a preparation defect is minor or localized, system 100 may decide to proceed with scanning while applying targeted mitigation strategies such as adaptive exposure or localized masking. Without limitation, by integrating pre-scan quality control for slide-preparation defects, system 100 may ensure that the imaging workflow begins only when the physical slide conditions support high-quality data capture.

With continued reference to FIG. 1, in a non-limiting example, system 100 may be configured to reject or pause a scan when the system detects preparation defects that prevent successful imaging. During the pre-scan evaluation, system 100 may analyze macro or low-magnification images to identify issues such as debris, tissue folds, air bubbles, pen marks, uneven staining, or tissue extending beyond the coverslip. When system 100 determines that a preparation defect makes high-quality image acquisition impossible or would lead to repeated failures during focus, illumination, or coverage routines, the system may pause the workflow before high-magnification scanning begins. This pause may allow system 100 to prevent wasted scan time, avoid collecting unusable data, and maintain stable operation of the imaging components. In a non-limiting example, when system 100 identifies a preparation defect that cannot be corrected through on-scanner remediation, the system 100 may reject the scan entirely and generate an automated alert instructing the operator to correct the defect off-scanner. This guidance may include cleaning the slide, removing debris, addressing mounting anomalies, or preparing a new slide when necessary. When the defect is less severe but still impactful, system 100 may pause the scan, provide contextual information about the defect, and wait for operator input regarding whether to continue, adjust settings, or halt the scan. Through this approach, system 100 may ensure that imaging proceeds only under conditions where reliable and diagnostically meaningful data can be obtained.

With continued reference to FIG. 1, in a non-limiting example, system 100 may be configured to detect preparation defects during the scan itself by analyzing early high-magnification image frames or intermediate scan data. Even when a slide passes pre-scan evaluation, certain preparation defects become visible only under high-resolution optical conditions. These include microtomy defects where the tissue surface contains chatter marks or compression artifacts, tearing where tissue regions exhibit rips or missing sections, and thickness variation where the tissue exhibits uneven vertical profiles that destabilize focus and illumination. As system 100 acquires image data, the system 100 may evaluate textural consistency, edge continuity, tissue uniformity, focus-stack behavior, and the like to identify these defects. Machine learning models, gradient-based feature detectors, spatial-frequency analysis, and the like may highlight irregularities that indicate underlying preparation problems rather than scan-time anomalies. In a non-limiting example, once system 100 detects a preparation defect during the scan, the system 100 may determine whether the defect disrupts the imaging process sufficiently to require intervention. When microtomy chatter alters focus reliability across large regions, when tearing removes diagnostically relevant tissue, or when thickness variation causes recurrent focus failures, system 100 may pause imaging and generate an automated alert instructing the operator that the slide exhibits preparation issues that cannot be corrected through scanning adjustments. As used in this disclosure, “microtomy chatter” is a preparation-induced defect that occurs when a tissue section is cut unevenly during microtomy. In an embodiment, the microtomy chatter may produce a series of fine, periodic compression marks or ripples across the tissue surface that disrupt uniform morphology and impair downstream imaging consistency. Without limitation, when the defect is localized or mild, system 100 may continue scanning unaffected regions while attempting selective reacquisition or adaptive-focus techniques in problematic zones. In an embodiment, by incorporating in-scan detection of preparation defects, system 100 may ensure accurate interpretation of defect origin, preserve image quality, and minimize the risk of collecting incomplete or misleading data.

With continued reference to FIG. 1, in a non-limiting example, system 100 may be configured to detect incorrect coverslip orientation as a preparation defect that interferes with reliable imaging. A coverslip applied at an angle, shifted laterally, or rotated relative to the slide frame may produce uneven optical interfaces, variable tissue-to-coverglass spacing, or unexpected refractive artifacts during scanning. To identify these conditions, system 100 may analyze macro-level imagery to locate the geometric boundaries of the coverslip and compare its measured orientation against expected positional templates. The ability to confirm proper coverslip placement enables system 100 to prevent focus instability, avoid incomplete coverage, and maintain an optical configuration suitable for high-quality imaging.

With continued reference to FIG. 1, in a non-limiting example, system 100 may be configured to detect reversed fiduciary-marker orientation by analyzing slide markings or etched alignment indicators used to establish coordinate reference frames during scanning. A reversed slide disrupts spatial consistency, interferes with tissue localization algorithms, and causes systematic mismatch between expected and actual scan geometry. To identify this condition, system 100 may perform pattern recognition on fiduciary markers located at predefined positions on the slide. Accurate detection of an incorrect orientation may allow system 100 to maintain geometric accuracy, prevent misregistration, and ensure that downstream analyses rely on correctly oriented image data.

With continued reference to FIG. 1, in a non-limiting example, system 100 may include a fiduciary-marker recognition module configured to identify, locate, and interpret reference markers present on the slide or coverslip. These markers may establish coordinate anchors that support alignment of macro imagery, planning of scanning trajectories, and consistent orientation across imaging sessions. The fiduciary-marker recognition module may employ feature detectors, template-matching routines, or trained vision models to distinguish fiduciary markers from tissue structures and preparation artifacts. Successful identification and registration of fiduciary markers enable system 100 to confirm slide placement, validate orientation, and maintain precise spatial calibration throughout the imaging workflow.

With continued reference to FIG. 1, in a non-limiting example, system 100 may be configured to detect overflow of mounting medium such as DPX that extends beyond the coverslip and onto the exposed slide surface. Mounting-medium overflow alters the optical interface, produces high-gloss reflective regions, and may trap air bubbles or debris that degrade image fidelity. During pre-scan imaging, system 100 may evaluate reflectance patterns, surface continuity, and texture irregularities to identify glossy or uneven regions characteristic of excess mounting medium. Detection of such overflow may allow system 100 to classify the condition as a preparation defect and to generate an automated alert instructing the operator to address the issue before scanning, ensuring stable optical conditions for reliable image acquisition.

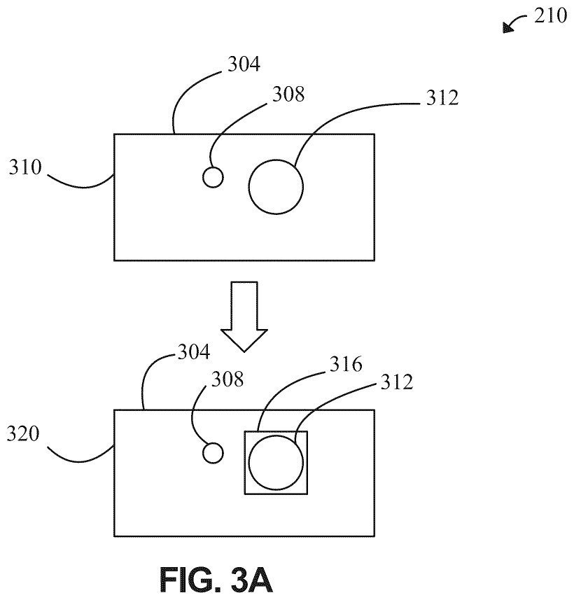

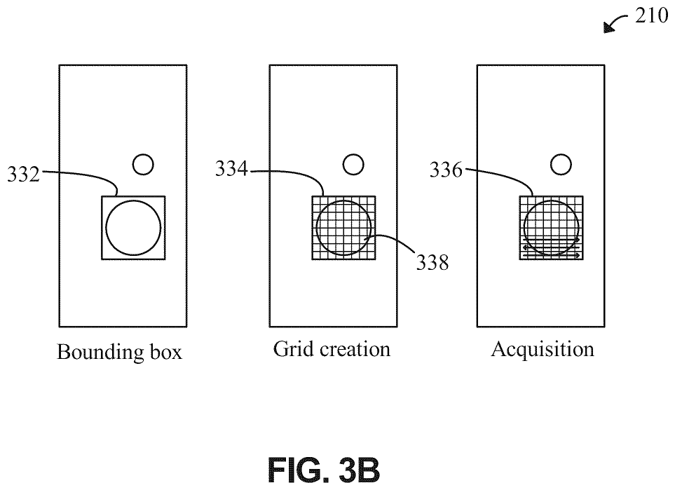

FIGS. 2-7B are simplified diagrams of a data flow 200 for inline quality control according to some embodiments. FIG. 2 provides an overview of data flow 200, and FIGS. 3-7B illustrate certain modules of data flow 200 in greater detail. In some embodiments consistent with FIG. 1, data flow 200 may be implemented using inline quality control program 150 in conjunction with other components and/or features of system 100, as further described below.

Referring now to FIG. 2, in general, data flow 200 includes a set of modules 210-260 (described in further detail below) that correspond to steps in the slide digitization process. Within each module, inline quality control methods are in place to trap errors that can be fixed at that stage below an acceptable threshold for downstream processing. Additionally, or alternately, the inline quality control methods associated with each module may accumulate deviations of observed features from acceptable thresholds and pass the deviations to the next module. In this sense, data flow 200 conceptually resembles a directed computation graph with directed edges leading back to the beginning with information to perform a second pass selectively to fix errors. Most nodes in the graph have automatically determined quality acceptance tests baked in, with tuned thresholds that determine if the processed image proceeds to the next stage or is fed back to the beginning to correct for specific errors detected. For images that are finally output, the errors are within acceptable thresholds. Additionally, the errors that are present in those slides are demarcated for downstream algorithms to avoid or fix. For instance, generative models like diffusion models can leverage these delineated regions to perform inpainting which is then used for downstream tasks.

Still referring to FIG. 2, in some embodiments, system 100 performs a scan of a slide. System 100 may perform a scan of a slide by capturing at least a first image and capturing at least a second image. Performing a scan may include identifying a first scanning parameter. As used herein, a “scanning parameter” is a setting at which a device captures an image. In non-limiting examples, a scanning parameter may include a focal depth, a (x,y) position, a magnification level, an aperture, a shutter speed, an ISO sensitivity, and a level of backlighting. In some embodiments, a first scanning parameter may include which of a plurality of optical sensors to use to capture an image. For example, first scanning parameter may configure a device to capture a macro image of a whole slide and/or an entirety of a sample on a slide. As used herein, a “macro image” is an image in which entirety of a sample on a slide is in frame. In another example, at least a first image includes an image of a region of a sample. Such a macro image may be a wider angle image than subsequently captured images. Such a macro image may include a lower resolution image than a subsequently captured image. Such a macro image may be used to determine subsequent scanning parameters, as described herein. In some embodiments, a macro image may be captured at 1× magnification. In some embodiments, a macro image may be captured using a 5 megapixel camera.

Still referring to FIG. 2, in some embodiments, performing a scan of a slide may include, using an optical system, capturing at least a first image as a function of a first scanning parameter. In some embodiments, at least a first image may be captured at a first position as a function of first scanning parameter. In some embodiments, capturing at least a first image of a slide may include using actuator mechanism and/or actuator controls to move optical system and/or slide into desired positions.

Still referring to FIG. 2, in some embodiments, system 100 may determine a first quality metric as a function of at least a first image. As used herein, a “quality metric” is a datum describing an assessment of a quality of an image, a quality of a section of an image, a quality of a feature of an image, or a combination thereof. In a non-limiting example, a quality metric may describe a degree to which an image and/or a section of an image is in focus. Non-limiting examples of quality metrics include localization quality metric, focus sampling quality metric, biopsy plane estimation quality metric, z-stack acquisition quality metric, and stitching quality metric, each of which is described further herein.

Still referring to FIG. 2, in some embodiments, system 100 may determine a second scanning parameter as a function of first quality metric. System 100 may, using an optical system, capture at least a second image as a function of second scanning parameter. Examples of quality metrics, and their associated scanning parameters are described further below. In some embodiments, at least a second image may be made up of a plurality of high resolution images. Such high resolution images may be stitched together to construct at least a second image which covers a desired area, such as an entire sample or region of interest. In some embodiments, at least a first image may be captured at a first location, and at least a second image may be captured at a second location. For example, a first location may be determined as a function of first scanning parameter, and may include a default location, a location input by a user, or the like. As an example, a second location may be determined as a function of a localization module as described further herein.

Still referring to FIG. 2, in some embodiments, system 100 may determine multiple quality metrics. For example, system 100 may determine localization quality metric, focus sampling quality metric, biopsy plane estimation quality metric, z-stack acquisition quality metric, and stitching quality metric simultaneously. In some embodiments, system 100 may determine one or more scanning parameters and/or capture one or more images based on such quality metrics. For example, system 100 may first determine localization quality metric, then may determine a scanning parameter and may capture a subsequent image using such scanning parameter. System 100 may then determine focus sampling quality metric, may determine a subsequent scanning parameter, and may capture a subsequent image using such scanning parameter.

Referring now to FIGS. 2 and 3A-3B, first quality metric may include a localization quality metric; and determining second scanning parameter may include identifying at least a region of interest of slide 304. As used herein, a “region of interest” is a specific area within a slide, or a digital image of a slide, in which a feature is detected. A feature may include, in non-limiting examples, debris 308 sample 312, writing on a slide, a crack in a slide, a bubble, and the like. In some embodiments, a feature includes a sample, such as a biological sample. As used herein, a “localization quality metric” is a quality metric which assesses the performance of a localization module. In some embodiments, localization quality metric may include one or more composite measures used to evaluate the precision and reliability of localization module's ability to detect and position the sample within an image. In other embodiments, localization quality metric may include one or more quantifiable measures utilized by localization module within the system designed to identify region of interest 316. As shown in FIGS. 2 and 3A-3B, data flow 200 includes a localization module 210. As used herein, a “localization module” is an automatic system for identifying a region of interest. Localization module 210 receives an image 310 of slide 304 (shown in FIG. 3A), such as one of images 121-129. In some embodiments, image 310 may be captured at a low magnification level (e.g., 1×) and the field of view may cover a substantial portion of slide 304 (e.g., the image may include most of slide 304, including regions containing the biomedical specimens).

Still referring to FIGS. 2 and 3A-3B, based on image 310, localization module 210 localizes regions of interest 316 on slide 304. For example, as illustrated by image 320, localization module 210 may identify portions of slide 304 that contain biomedical specimens and other slide attributes including but not limited to the color intensity of stained tissue (e.g., dark or faint), the size, shape, and position of the specimen, debris, cover slip boundaries, annotations (e.g., handwritten text, printed text, scanning codes, arrows and markings, or the like), or the like. Localizing regions of interest 316 on slide 304 may be performed by a variety of suitable image processing techniques, including techniques that use machine learning models trained to identify the selected regions of interest. Annotations may be identified using, for example, an optical character recognition (OCR) system.

Still referring to FIGS. 2 and 3A-3B, based on the identified areas of interest, localization module 210 may select one or more portions of the slide to be scanned at a higher magnification level (e.g., 10×, 20×, or 40× magnification). For example, localization module 210 may identify one or more bounding boxes 332 that represent the portions of the slide to be scanned at the higher magnification level, e.g., portions containing the biomedical specimen. Localization module 210 may then form a grid 334 (or other suitable pattern) for each bounding box 332 that identifies the x, y, and/or z coordinates of the desired images to be captured at the higher resolution. In addition, localization module 210 may identify a scanning pattern 336 (e.g., a raster scanning pattern having a primary scanning direction and a secondary scanning direction) that specifies a particular sequence in which the desired images are to be acquired. In some embodiments, localization module 210 may identify one or more features during localization. Such features may include, in non-limiting examples, samples, bubbles, debris, and annotations. In some embodiments, localization module 210 may determine a localization module confidence score. As used herein, a “localization module confidence score” is a data structure describing a likelihood that a feature of a particular category is present in a particular location, region, or both. For example, a first localization module confidence score may be determined with respect to a particular region of a slide, where the first localization module confidence score describes the likelihood that the region contains an annotation. In this example, a second localization module confidence score may be determined with respect to a particular region of a slide, where the second localization module confidence score describes the likelihood that the region contains a biological sample. In some embodiments, localization module 210 may identify a region of interest as a function of one or more localization module confidence scores. For example, localization module 210 may identify a region of interest as a function of a localization module confidence score describing the likelihood that a biological sample is present. In some embodiments, high magnification probing may be used to determine whether a feature, such as a biological sample, is present. For example, high magnification images may be captured of a plurality of regions of a slide, and such high magnification images may be analyzed to determine whether a feature (such as a biological sample) is present. In some embodiments, high magnification probing may be used to determine a region of interest which does not include a region with a low probability of containing a feature such as a biological sample.

Still referring to FIGS. 2 and 3A-3B, in some embodiments, localization module 210 may select one or more reference points 338 within grid 334 for further imaging and analysis, such as biopsy plane estimation or focus sampling, as further described below. As used herein, a “reference point” is a point within a grid whose focal distance, determined by one or more predetermined criteria, is used to calculate the focal distance of another point. In some embodiments, the optimal focal distance of a reference point is used to calculate the optimal focal distance of a different point. For example, reference point 338 may correspond to a point at the center of bounding box 332, a point having the maximum color intensity within bounding box 332, a point determined to be the most likely to contain a biomedical specimen (e.g., as determined using a machine learning model), or another suitable selection criteria.

Still referring to FIGS. 2 and 3A-3B, in some embodiments, localization module 210 may include one or more inline quality controls. For example, and without limitation, localization module 210 characterizes the content present on the slide, may check that image 310 is in focus, that image 310 includes the biological specimen within the field of view, that an amount of debris on the slide or other unwanted artifacts or noise in image 310 does not exceed a predetermined threshold, that a confidence level associated with identifying areas of interest exceeds a predetermined threshold, or the like. When one or more checks returns a negative result, one or more remedial actions may be taken, such as recapturing image 310 with different exposure settings, bringing image processing/ML algorithms to enhance the image etc., indicating to a lab admin the slide preparation, or the like. In some embodiments, the inline quality checks may output information associated with the results of the quality checks, such as a numerical score or an indication of areas of a slide that were found to be low quality, that can be used by subsequent modules in data flow 200.

Still referring to FIGS. 2 and 3A-3B, in some embodiments, the areas of interest identified by localization module 210 may be provided to downstream applications for further processing. For example, localization module 210 may provide a mask to delineate areas of interest with artifacts that should be avoided, inpainted, or otherwise handled by the downstream application.

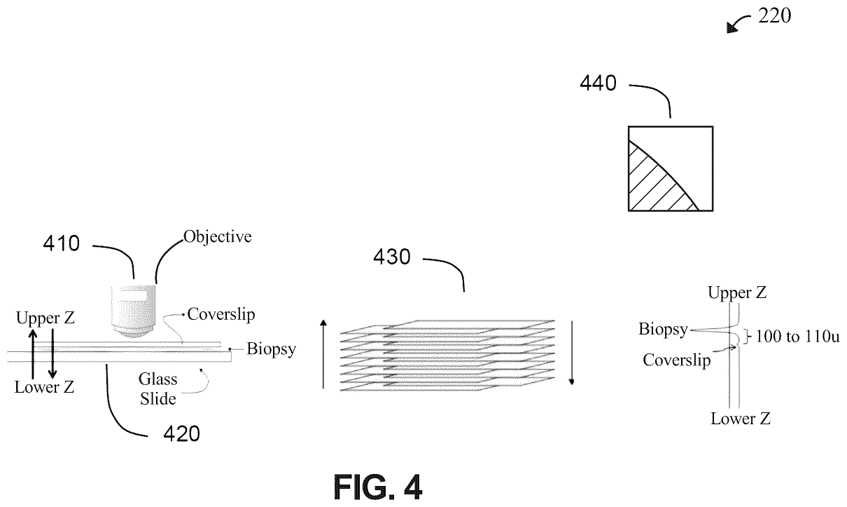

Referring now to FIGS. 2 and 4, first quality metric may include biopsy plane estimation quality metric; and determining second scanning parameter may include identifying a plane within a region of interest which contains a biological specimen. As used herein, a “biopsy plane estimation quality metric” is a quality metric which assesses the performance of a biopsy plane estimation module. In some embodiments, biopsy plane estimation quality metric may include one or more composite measures used to evaluate the precision and reliability of biopsy plane estimation module's ability to identify a plane within a region of interest which contains a biological specimen. In other embodiments, localization quality metric may include one or more quantifiable measures utilized by localization module within the system designed to identify a plane within a region of interest which contains a biological specimen. As depicted in FIGS. 2 and 4, data flow 200 may include a biopsy plane estimation module 220. As used herein, a “biopsy plane estimation module” is an automatic system for identifying a plane within a region of interest which contains a biological specimen. Biopsy plane estimation module 220 instructs a scanner 410 (shown in FIG. 4) to perform a scan along the z-axis of a slide 420 at high magnification to identify the plane that contains the biomedical specimen of interest (e.g., a biopsy). For example, scanner 410 may correspond to one of scanners 101-109. Scanner 410 may acquire a series of images 430 along the z-axis using the same high magnification objective lens (e.g., 10×, 20×, or 40×) that will ultimately be used to acquire images used for the digitized slide. One or more attributes of the series of images 430 (e.g., color intensity) may be analyzed to estimate the plane containing the biopsy (or other biomedical specimen), as shown illustratively at process 440. For example, the biopsy plane may correspond to the z-axis coordinate that produces an image with the maximum color intensity.

Still referring to FIGS. 2 and 4, in some embodiments, biopsy plane estimation module 220 may perform biopsy plane estimation at x and y coordinates corresponding to reference point 338 (shown in FIG. 3B), e.g., a point determined by localization module 210 to be optimal for biopsy plane estimation. Performing biopsy plane estimation at reference point 338 may improve efficiency by ensuring that the biopsy plane estimation is performed at a location likely to contain a biomedical specimen. For example, the likelihood that biopsy plane estimation is repeated at different locations on the sample, or the likelihood that manual intervention is used to select or adjust the location for biopsy plane estimation, is reduced.

Still referring to FIGS. 2 and 4, in some embodiments, biopsy plane estimation module 220 may include one or more inline quality controls. For example, biopsy plane estimation module 220 may check that the biopsy plane estimation is performed at a location that contains a sufficient amount of the biomedical specimen to accurately perform biopsy plane estimation. When the check returns a negative result, one or more remedial actions may be taken, such as selecting a different location to perform biopsy plane estimation, generating an alert that insufficient biomedical specimen was detected, or the like. In some embodiments, biopsy plane estimation module 220 may output information associated with the results of the quality checks, such as a numerical score, that can be used by subsequent modules in data flow 200. The information may be aggregated with information supplied by preceding modules in data flow 200 (e.g., localization module 210) to provide a running indicator of the quality of the slide digitization process, which may trigger further remedial actions (e.g., rescans or alerts) when the running indictor exceeds a predetermined threshold.

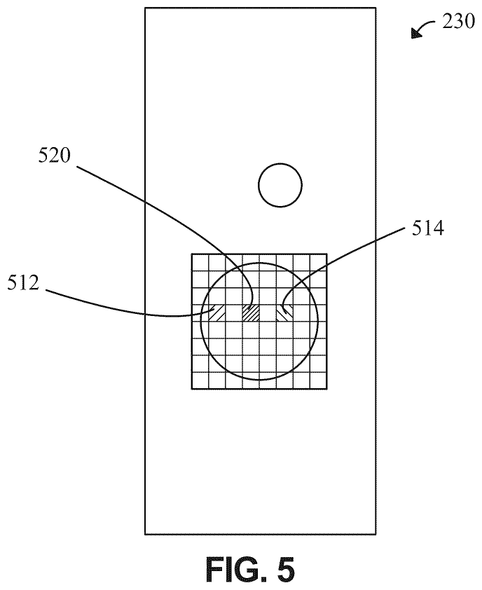

Referring now to FIGS. 2 and 5, first quality metric may include focus sampling quality metric; and determining second scanning parameter may include identifying a focal setting at which a selected point is in focus. As used herein, a “focus sampling quality metric” is a quality metric which assesses the performance of a focus sampling module. In some embodiments, focus sampling quality metric may include one or more composite measures used to evaluate the precision and reliability of focus sampling module's ability to identify a focal setting at which a selected point is in focus. In other embodiments, focus sampling quality metric may include one or more quantifiable measures utilized by focus sampling module within the system designed to identify a focal setting at which a selected point is in focus. As depicted in FIGS. 2 and 5, data flow 200 may include a focus sampling module 230. As used herein, a “focus sampling module” is an automated system for identifying a focal setting at which a selected point is in focus. Focus sampling module 230 may carry out focus optimization at two or more sample points 512 and 514 (shown in FIG. 5) within the scanning grid (e.g., grid 334). Sample points 512 and 514 may be selected in relation to a reference point 520 (e.g., reference point 338). For example, sample points 512 and 514 may be positioned along a same row of the scanning grid as reference point 520. At each of sample points 512 and 514, focus sampling module 230 may instruct the scanner to determine optimal focus settings for subsequent imaging. For example, the optimal focus settings at sample points 512 and 514 may be determined using a variety of known techniques for auto-focusing, e.g. sharpness of the image. When the optimal focus settings at sample points 512 and 514 are different, focus sampling module 230 may determine a gradient (or other suitable functional relationship) of the focus settings such that optimal focus settings for the remaining points in the scanning grid may be estimated, e.g., by interpolation. Focus sampling may therefore provide an efficient technique for estimating the optimal focus settings throughout the scanning grid by performing optimization at a subset of the points in the grid and using gradients to estimate the optimal settings at the remaining points.

Still referring to FIGS. 2 and 5, in some embodiments, focus sampling module 230 may include one or more inline quality controls. For example, focus sampling module 230 may check that the focus sampling is performed at locations that contain a sufficient amount of the biomedical specimen to accurately determine the focus settings. This may be performed by estimating the quality of specimen (e.g. thickness of specimen in z-direction), checking attributes of the specimen such as whether the specimen present on the glass slide corresponds to tissue versus annotation (e.g., pen marks), and confirming planarity of the slide estimated. Such locations may include, in non-limiting examples, fields of view of high resolution images of sections of a slide. When such a check returns a negative result, one or more remedial actions may be taken, such as selecting different locations to perform focus sampling, generating an alert that insufficient biomedical specimen was detected, or the like. In some embodiments, focus sampling module 230 may output information associated with the results of the quality checks, such as a numerical score, that can be used by subsequent modules in data flow 200. The information may be aggregated with information supplied by preceding modules in data flow 200 (e.g., modules 210-220) to provide a running indicator of the quality of the slide digitization process, which may trigger further remedial actions (e.g., rescans or alerts) when the running indictor exceeds a predetermined threshold. In some embodiments, focus sampling inline quality controls may include identifying locations where focus sampling errors are present. For example, locations which are out of focus may be identified, and remedial actions (such as rescans) may be taken for those areas. In some embodiments, such locations may include fields of view of high resolution images of sections of a slide.

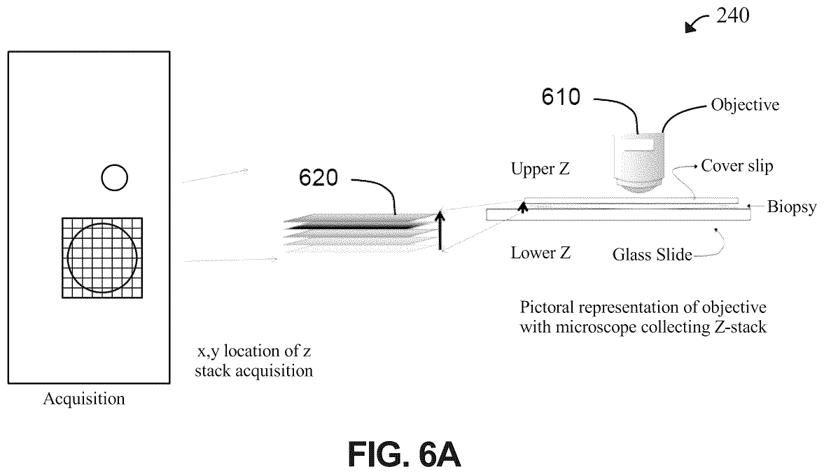

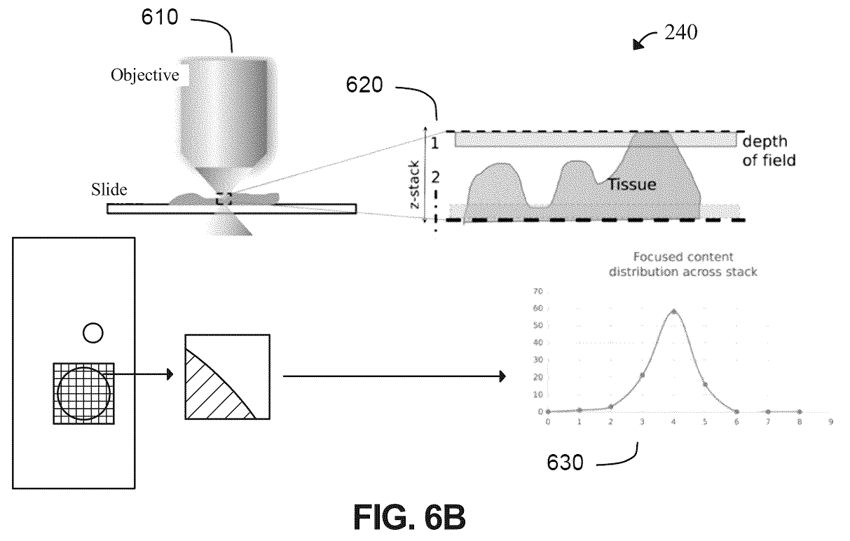

Referring now to FIGS. 2 and 6A-6B, first quality metric may include z-stack acquisition quality metric; and determining second scanning parameter may include using the optical system, capturing a z-stack at a selected point. As used herein, a “z-stack acquisition quality metric” is a quality metric which assesses the performance of a z-stack acquisition module. As depicted in FIGS. 2 and 6A-6B, data flow 200 may include a z-stack acquisition module 240. Based on information provided by preceding modules 210-240 (e.g., the scanning pattern, biopsy plane, and focus settings), z-stack acquisition module 240 instructs a scanner 610 (shown in FIGS. 6A-6B) to acquire a set of images 620 (referred to as a z-stack) along the z-axis of a slide at high magnification. For example, scanner 610 may correspond to one of scanners 101-109. As shown in FIG. 6B, the images in the z-stack may be acquired by sweeping the depth of field using an objective lens of scanner 610. In this manner, features of the biomedical specimen (e.g., the tissue sample) that vary along the z-axis, such as bumps, ridges, and other 3-dimensional features, may come into focus in different layers of the z-stack. In some embodiments, z-stack acquisition module 240 may output an aggregate image based on the set of images in the z-stack. For example, as illustrated in FIG. 6B at process 630, the aggregate image may correspond to a selected image from the z-stack that contains the most in-focus content among the images in the set. Other suitable techniques for aggregating the z-stack images may be used. Z-stack acquisition module 240 may acquire z-stack images at each x-y location in the sample to be scanned (e.g., as determined by localization module 210).

Still referring to FIGS. 2 and 6A-6B, in some embodiments, z-stack acquisition module 240 may include one or more inline quality controls. For example, z-stack acquisition module 240 may check that the amount of in focus image content in the z-stack exceeds a predetermined threshold, that the amount of debris or imaging artifacts in the images is below a predetermined threshold, that the levels of tissue folding and/or slide preparation artifacts are below a predetermined threshold, that the tissue is inside/outside the coverslip or the like, that the detected specimen corresponds to tissue rather than an annotation, or the like. When one or more of these checks return a negative result, one or more remedial actions may be taken, such as reacquiring the z-stack, adjusting the position of the z-stack (e.g., capturing images at a different position along the z-axis), adjusting the z stack size, generating an alert, or the like.

Still referring to FIGS. 2 and 6A-6B, in some embodiments, z-stack acquisition module 240 may track quality indicators associated with each z-stack as scanning proceeds throughout the scanning grid. For example, z-stack acquisition module 240 may count the locations in the scanning grid for which the quality checks produced negative results and may perform a remedial action when the count exceeds a predetermined threshold. In some embodiments, z-stack acquisition module 240 may generate and display a map indicating the quality of each z-stack in the scanning grid.

Still referring to FIGS. 2 and 6A-6B, in some embodiments, z-stack acquisition module 240 may output information associated with the results of the quality checks, such as a numerical score or a map indicating the quality of the z-stack scan at each location in the slide. This information can be used by subsequent modules in data flow 200. The information may be aggregated with information supplied by preceding modules in data flow 200 (e.g., modules 210-230) to provide a running indicator of the quality of the slide digitization process, which may trigger further remedial actions (e.g., rescans or alerts) when the running indictor exceeds a predetermined threshold.

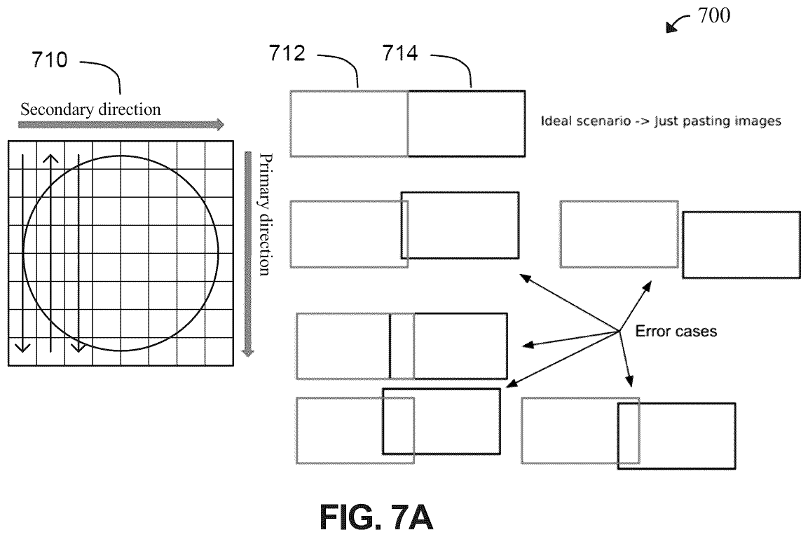

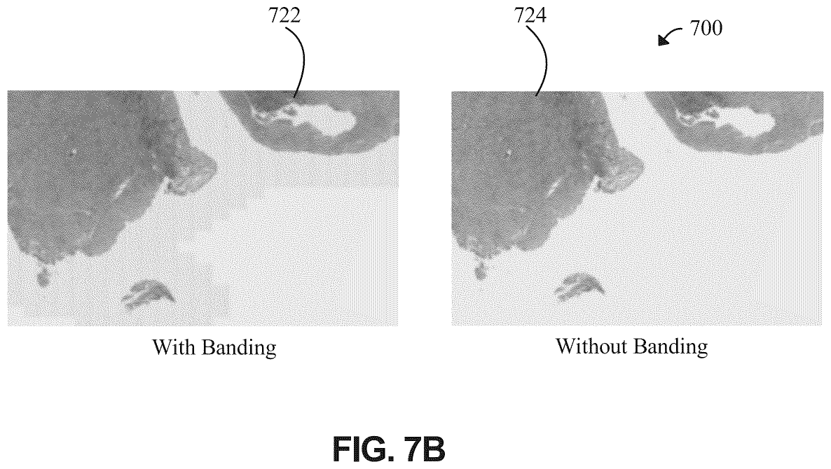

Referring now to FIGS. 2 and 7A-7B, an illustration 700 of performing a scan of a slide may include, using an optical system, capturing at least a second image as a function of second scanning parameter. In some embodiments, capturing at least a second image may include capturing a plurality of images, and stitching such images together. In some embodiments, performing a scan of a slide may include determining a stitching quality metric as a function of the at least a second image. In some embodiments, performing a scan of a slide may further include determining a third scanning parameter as a function of the stitching quality metric; using the optical system, capturing a second plurality of images as a function of the third scanning parameter; and combining the second plurality of images to create at least a third image. For example, if stitching quality metric is determined such that severe stitching related errors are identified, then additional images may be captured of an affected region, and such images may be used to assemble a corrected image. In some embodiments, image data from both at least a second image and subsequently captured image data is used to assemble at least a third image. As used herein, a “stitching quality metric” is a quality metric which assesses the performance of a stitching module. In some embodiments, stitching quality metric may include one or more composite measures used to evaluate the precision and reliability of stitching module's ability to assemble a larger image from a plurality of images. In other embodiments, localization quality metric may include one or more quantifiable measures utilized by localization module within the system designed to assemble a larger image from a plurality of images. As depicted in FIGS. 2 and 7A-7B, data flow 200 may include a stitching module 250. As used herein, a “stitching module” is an automated system for assembling a larger image from a plurality of images. Stitching module 230 aligns and stitches together (also referred to as pasting or fusing) adjacent images within the scanning grid 710 (shown in FIG. 7A) to form an aggregated output image. In an ideal scenario, each pair of adjacent images acquired by the scanner (e.g., images 712 and 714) is aligned without observable gaps 724, overlaps, or offsets between the images, including in the x, y, and z directions. In practice, however, such defects may be present and may result in artifacts such as ghosting (e.g., regions that are blurred due to stitching errors). Another type of artifact that may arise due to stitching is the visual effect of banding, as illustrated in FIG. 7B. In an image with banding 722, artifacts such as vertical lines may appear along the axes corresponding to the scanning grid.

Still referring to FIGS. 2 and 7A-7B, in some embodiments, stitching module 250 may include one or more inline quality controls to address stitching errors, such as ghosting artifacts and displacement. For example, stitching module 250 may check that the presence of such artifacts in the output image is below a predetermined threshold. When the threshold is exceeded, one or more remedial actions may be taken, such as rescanning portions of the slide where the artifacts were present, or the like. Additional remedial actions may include triggering a non-inline stitching process. For example, A scanning process may be completed, and a subsequent stitching process may be started. In some embodiments, the inline quality checks may output information associated with the results of the quality checks, such as a numerical score indicating the level of stitching artifacts, that can be used by subsequent modules in data flow 200. The information may be aggregated with information supplied by preceding modules in data flow 200 (e.g., modules 210-240) to provide a running indicator of the quality of the slide digitization process, which may trigger further remedial actions (e.g., rescans or alerts) when the running indictor exceeds a predetermined threshold.

Returning to FIG. 2, performing a scan may further include determining a second quality metric as a function of at least a first image; determining a combination quality metric as a function of first quality metric and second quality metric; determining a third scanning parameter as a function of the combination quality metric; and using optical system, capturing at least a third image as a function of second scanning parameter. Data flow 200 may include a whole slide assessment module 260. As used herein, a “whole slide assessment module” is an automated system for analyzing an output image generated by a stitching module. Whole slide assessment module 260 may perform a variety of quality checks on the output image and/or may synthesize the results of quality checks performed by modules 210-250. For example, whole slide assessment module 260 may perform a final quality check on the output image to trap out of focus, stitching, banding, missed specimen, z-stack shift errors (x,y shift across the image along the z plane of stack), or the like. When the check produces a negative result, one or more remedial actions may be taken such as rescanning portions of the slide where the errors were detected. In some embodiments, the slide may remain in the scanner during these quality checks, such that taking a remedial action (e.g., rescanning a portion of the slide) involves little or no additional setup time.

Still referring to FIG. 2, in some embodiments, whole slide assessment module 260 may generate or compile a representation of the slide (e.g., a map or other suitable representation) that delineates portions of the output image in which artifacts persist but are within an acceptable threshold (e.g., portions in which errors are detected but not fully resolved by the quality controls identified above). The representation may enable the downstream application to handle the remaining artifacts in a suitable manner, e.g., by avoiding or applying inpainting techniques to the portions of the image that contain artifacts.

Still referring to FIG. 2, in some embodiments, performing a scan of a slide may further include algorithmically removing a banding error from an image such as at least a second image. In some embodiments, banding errors may be a product of non-uniform lighting across images and/or regions of images.

Still referring to FIG. 2, in some embodiments, an error may be flagged. For example, an error may be flagged based on a quality metric. In some embodiments, an error may be flagged as a function of a focus sampling quality metric. In some embodiments, an error may be flagged as a function of a stitching quality metric. In some embodiments, an error may be flagged if re-scanning a slide and/or a region of a slide does not sufficiently lead to a reduction in a quality metric. In some embodiment, prevalence and/or severity of errors may be tracked using a map. For example, a map may depict sections of an image and quality metrics associated with such sections of the image. For example, a map may include an overlay over an image which is color coded according to a particular quality metric and/or an aggregate measure of multiple quality metrics. In some embodiments, a map may be used to expedite manual quality control of an image. For example, a map may be output to a user using a display as described below in order to aid the user in a quality control process.

Still referring to FIG. 2, in some embodiments, system 100 may transmit one or more images and/or maps to an external device. Such an external device may include, in non-limiting examples, a phone, tablet, or computer. In some embodiments, such a transmission may configure the external device to display an image.

Still referring to FIG. 2, in some embodiments, system 100 may determine a visual element data structure. In some embodiments, system 100 may display to a user a visual element as a function of visual element data structure. As used herein, a “visual element data structure” is a data structure describing a visual element. As non-limiting examples, visual elements may include at least a first image, at least a second image, at least a third image, a map, and elements of a GUI.

Still referring to FIG. 2, in some embodiments, a visual element data structure may include a visual element. As used herein, a “visual element” is a datum that is displayed visually to a user. In some embodiments, a visual element data structure may include a rule for displaying visual element. In some embodiments, a visual element data structure may be determined as a function of first image, second image, and/or hybrid image. In some embodiments, a visual element data structure may be determined as a function of an item from the list consisting of at least a first image, at least a second image, at least a third image, elements of a GUI, first scanning parameter second scanning parameter, third scanning parameter, first quality metric, and stitching quality metric. In a non-limiting example, a visual element data structure may be generated such that visual element depicting at least a second image is displayed to a user.

Still referring to FIG. 2, in some embodiments, visual element may include one or more elements of text, images, shapes, charts, particle effects, interactable features, and the like. As a non-limiting example, a visual element may include a touch screen button for setting magnification level.

Still referring to FIG. 2, a visual element data structure may include rules governing if or when visual element is displayed. In a non-limiting example, a visual element data structure may include a rule causing a visual element including a scanning parameter to be displayed when a user selects an image captured using that scanning parameter using a GUI.

Still referring to FIG. 2, a visual element data structure may include rules for presenting more than one visual element, or more than one visual element at a time. In an embodiment, about 1, 2, 3, 4, 5, 10, 20, or 50 visual elements are displayed simultaneously. For example, a plurality of images and/or GUI elements may be displayed simultaneously.

Still referring to FIG. 2, in some embodiments, system 100 may transmit visual element to a display such as output interface. A display may communicate visual element to user. A display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, that allow user to input data into the display. Interactive elements may be configured to enable interaction between a user and a computing device. In some embodiments, a visual element data structure is determined as a function of data input by user into a display.

Still referring to FIG. 2, a variable and/or datum described herein may be represented as a data structure. In some embodiments, a data structure may include one or more functions and/or variables, as a class might in object-oriented programming. In some embodiments, a data structure may include data in the form of a Boolean, integer, float, string, date, and the like. In a non-limiting example, a quality metric data structure may include an int value representing a degree to which an image is in focus. In some embodiments, data in a data structure may be organized in a linked list, tree, array, matrix, tenser, and the like. In some embodiments, a data structure may include or be associated with one or more elements of metadata. A data structure may include one or more self-referencing data elements, which processor may use in interpreting the data structure. In a non-limiting example, a data structure may include “<date>” and “</date>,” tags, indicating that the content between the tags is a date.

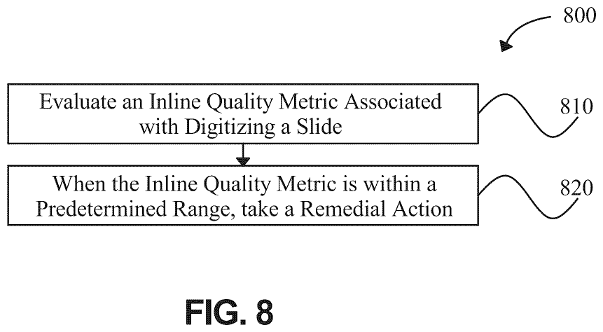

Referring now to FIG. 8, a simplified diagram of a method 800 for inline quality control of slide digitization according to some embodiments is provided. According to some embodiments consistent with other figures, method 800 may be performed by processor 130 during the execution of inline quality control program identification program 150. For example, method 800 may be performed using one or more of modules 210-260.

Still referring to FIG. 8, at process step 810, an inline quality metric associated with digitizing a slide is evaluated. In some embodiments, the inline quality metric may correspond to one or more of the inline quality controls described previously with respect to FIGS. 2-7B. For example, the inline quality metric may include a value that indicates the presence of defects in one or more slide images, such as debris, out-of-focus errors, stitching artifacts, misalignments, lack of a biomedical specimen, or the like. In some embodiments, the inline quality metric may correspond to an aggregate metric that is accumulated over multiple stages of the slide digitization process (e.g., multiple modules of data flow 200). The inline quality metric can be quantitative (e.g., a numerical score or a count), qualitative (e.g., good, fair, poor), or a combination thereof. Evaluating the inline quality metric may include applying a machine learning model trained to identify defects and/or other image features relevant to inline quality control.

Still referring to FIG. 8, at process step 820, a remedial action is taken in response to a determination that the inline quality metric is within a predetermined range. For example, the inline quality metric may be within the predetermined range when its value exceeds a predetermined threshold, drops below a predetermined threshold, takes on a value identified as being associated with a defect (e.g., “poor” or “out-of-focus”), or the like. In some embodiments, the remedial action may include taking one or more of the remedial actions described previously with respect to FIGS. 2-7B. For example, the remedial action may include rescanning all or a portion of the slide, alerting a clinician, fixing an identified defect (e.g., applying image processing methods to reduce artifacts, inpainting one or more portions of the image using a generative machine learning model, or the like), generating a representation of the slide that indicates the presence or locations of defects for downstream applications, or the like. In some embodiments, the remedial action may be taken prior to removing the slide from the scanner, such that the set-up and/or take-down time associated with the remedial action is reduced, and manual intervention is likewise reduced.

Still referring to FIG. 8, in some embodiments, there may be multiple predetermined ranges associated with different remedial actions. For example, when the inline quality metric falls within a first predetermined range (e.g., a range indicative of the slide having an acceptable level of defects), the remedial action may include fixing the identified defects and/or identifying the presence or location of the defects for downstream processing stages. When the inline quality metric falls within a second predetermined range (e.g., a range indicative of the slide having an unacceptable level of defects), the remedial action may include initiating a rescan and/or alerting a clinician.

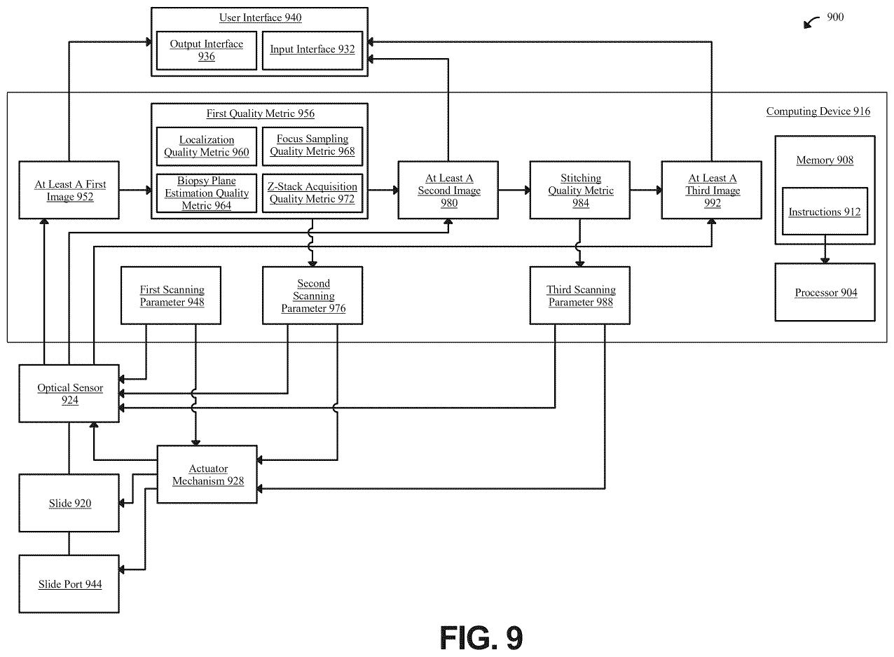

Still referring to FIG. 9, a box diagram depicting an exemplary embodiment of a system 900 for digitizing a slide is provided. System 900 may include processor 904, and memory 908 containing instructions 912 configuring processor 904 to perform one or more processes described herein. Computing device 916 may include processor 904, and memory 908, and may interact with other elements of system 900, such as by configuring elements of an optical system to capture images, configuring an actuator mechanism to move, configuring a user interface to display information and the like. System 900 may further include slide 920, such as a glass slide containing a biological sample. Optical sensor 924 may be used to capture one or more images of slide 920. Actuator mechanism 928 may be used to move optical sensor 924, slide port 944, and/or slide 920 into correct positions for images to be captured according to desired parameters. System 900 may further include input interface 932, such as a mouse and keyboard, output interface 936 such as a screen and speaker system, and user interface 940 which includes input interface 932 and output interface 936. Computing device 916 may use settings according to first scanning parameter 948 to capture at least a first image 952. At least a first image 952 may be used to determine first quality metric 956. First quality metric 956 may include localization quality metric 960, biopsy plane estimation quality metric 964, focus sampling quality metric 968, and/or z-stack acquisition quality metric 972. First quality metric 956 may be used to determine second scanning parameter 976. Settings of second scanning parameter 976 may be used to capture at least a second image 980. Stitching quality metric 984 may be determined as a function of at least a second image 980, such as in a case in which second image 980 is assembled from a plurality of images each covering narrower regions of slide 920. Third scanning parameter 988 may be determined as a function of stitching quality metric 984, and at least a third image 992 may be captured using settings of third scanning parameter 988. One or more of at least a first image 952, at least a second image 980, and at least a third image 992 may be displayed using user interface 940. In a non-limiting example, system 900 may capture a macro image which includes in frame the entirety of a biological sample which a user desires a high resolution image of. In this example, system 900 may use this macro image to identify one or more parameters for capturing subsequent images as described herein; such parameters may include a region within the macro image which contains the sample, a row within this region in which the sample is present, a focal distance at one or more points are in focus, and the like. In this example, system 900 may use such parameters to capture a plurality of images and may assemble a high resolution image from this plurality of images. This plurality of images may be checked for errors, such as stitching errors, and these errors may be corrected. A final image may be displayed to a user using a user interface.

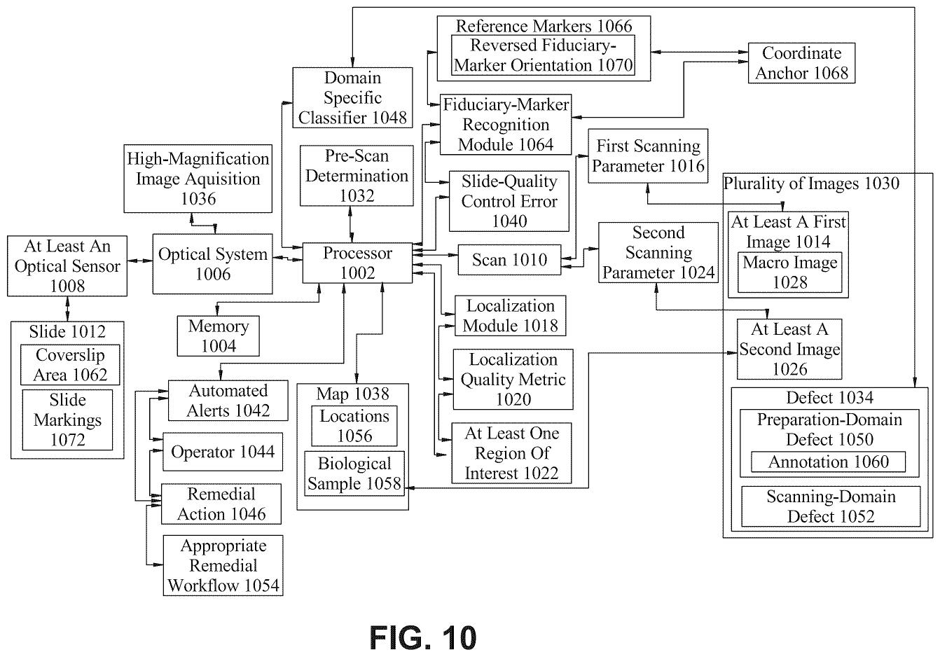

Referring now to FIG. 10, a system 1000 for digitizing a slide 1012. The system 1000 includes an optical system 1006 comprising at least an optical sensor 1008. Without limitation, the system 100 includes at least a processor 1002 communicatively connected to the optical system 1006. The at least a processor 1002 is configured to perform a scan 1010 of a slide 1012 by capturing at least a first image 1014 according to a first scanning parameter 1016. The at least a processor 1002 is configured to determine, using a localization module 1018, a localization quality metric 1020 as a function of the at least a first image 1014. The at least a processor 1002 is configured to identify, using the localization module 1018 and the localization quality metric 1020, at least one region of interest 1022 of the slide 1012. The at least a processor 1002 is configured to determine a second scanning parameter 1024 as a function of the localization quality metric 1020. The at least a processor 1002 is configured to capture, using the optical system 1006, at least a second image 1026 of the slide 1012 according to the second scanning parameter 1024.

With continued reference to FIG. 10, the at least a first image 1014 may include a macro image 1028 and capturing the at least a second image 1026 may include using the optical system 1006, capturing a first plurality of images 1030 and combining the first plurality of images 1030 to create the at least a second image 1026. As used in this disclosure, “macro image” is an image captured using an optical system 1006 at a field of view sufficient to include an entirety of a slide 1012 or an entirety of a specimen disposed on the slide 1012. In an embodiment, the macro image 1028 may be acquired using a low-magnification optical configuration to provide global spatial context for subsequent imaging operations. In a non-limiting example, the macro image 1028 may be used by a computing device to identify slide 1012 boundaries, coverslip boundaries, or gross specimen placement prior to higher-resolution scanning. Without limitation, the macro image 1028 may support automated decision-making by enabling software modules to determine scanning parameters, regions of interest, or pre-scan quality assessments. As used in this disclosure, “plurality of images” is two or more images captured using an optical system 1006, each image corresponding to a respective spatial location, focal depth, or imaging parameter, and collectively representing a larger or more detailed visual representation than a single image alone. In an embodiment, the plurality of images 1030 may be captured at adjacent positions across a slide 1012 and may together represent an extended area of a specimen. In a non-limiting example, the plurality of images 1030 may be captured at different magnifications or focus depths to resolve fine structural detail across the specimen. Without limitation, the plurality of images 1030 may be combined using computational techniques to generate a composite image that improves resolution, coverage, or analytical utility relative to any individual image. Without limitation, the macro image 1028 may be captured using dedicated low-magnification hardware such as a macro camera, a secondary optical path, or a wide-field sensor integrated into a slide 1012 scanner, while the plurality of images 1030 may be captured using a high-magnification objective, precision motion stages, and a high-resolution image sensor. In an embodiment, software executing on a processor 1002 may analyze the macro image 1028 to control actuators, select imaging trajectories, and coordinate acquisition of the plurality of images 1030, thereby reducing unnecessary scanning and improving throughput. Without limitation, combining macro-level hardware context with fine-grained image acquisition and computational image fusion represents an improvement to imaging technology by enabling automated, adaptive scanning workflows that increase efficiency, reduce operator 1044 intervention, and improve the quality and reliability of digitized slide 1012 data.

With continued reference to FIG. 10, the at least a processor 1002 may be further configured to perform a pre-scan determination 1032, wherein the determination comprises an identification of one or more defects within the macro image 1028, wherein the one or more defects prevent successful high-magnification image acquisition 1036. As used in this disclosure, “pre-scan determination” is a determination performed by at least a processor 1002 prior to image acquisition to assess whether a slide 1012 is suitable for further scanning. In an embodiment, the pre-scan determination 1032 may be executed after capture of a macro image 1028 and before initiation of fine-resolution imaging. In a non-limiting example, the pre-scan determination 1032 may evaluate slide-level conditions to decide whether to proceed with, pause, or terminate a scanning workflow. Without limitation, the pre-scan determination 1032 may support automated control of imaging hardware by preventing initiation of imaging operations that are unlikely to succeed. As used in this disclosure, “identification” is a process by which at least a processor 1002 detects, recognizes, or determines the presence of a condition, feature, or characteristic within image data. In an embodiment, identification may be performed using rule-based logic, image-processing algorithms, or machine learning models. In a non-limiting example, identification may include locating spatial regions within an image that satisfy predefined criteria. Without limitation, identification may produce data indicating existence, location, type, or severity of a detected condition. As used in this disclosure, “defect” is a condition or feature associated with a slide 1012 or specimen that degrades, obstructs, or prevents acquisition of usable image data. In an embodiment, a defect 1034 may originate from slide 1012 preparation, handling, or physical characteristics of the specimen. In a non-limiting example, a defect 1034 may interfere with optical focus, illumination uniformity, or spatial coverage during scanning. Without limitation, a defect 1034 may be classified based on its impact on imaging performance or downstream analytical reliability. As used in this disclosure, “high-magnification image acquisition” is the process of capturing image data using an optical system 1006 configured to resolve fine structural detail at magnifications greater than those used for macro imaging. In an embodiment, high-magnification image acquisition 1036 may involve precise positioning, focus control, and high-resolution optical components. In a non-limiting example, high-magnification image acquisition 1036 may include capturing multiple images across a slide 1012 to resolve cellular or subcellular features. Without limitation, high-magnification image acquisition 1036 may require stable optical and mechanical conditions to produce diagnostically or analytically reliable image data. In an embodiment, at least a processor 1002 may perform the pre-scan determination 1032 by analyzing a macro image 1028 to perform identification of one or more defects present within the macro image 1028. In a non-limiting example, the identification may include detecting slide-level conditions that interfere with optical stability, spatial coverage, or focus control required for high-magnification image acquisition 1036. Without limitation, when the one or more defects are determined to prevent successful high-magnification image acquisition 1036, the processor 1002 may inhibit initiation of high-magnification imaging to conserve system resources and maintain imaging reliability.

With continued reference to FIG. 10, the at least a processor 1002 may be further configured to pause the scan 1010 when the one or more defects are identified within the macro image 1028. Without limitation, at least a processor 1002 may be configured to pause the scan 1010 in response to identifying one or more defects within the macro image 1028, such that progression of the scanning workflow is temporarily halted prior to initiation or continuation of high-magnification image acquisition 1036. In an embodiment, pausing the scan 1010 may include preventing movement of an actuator mechanism, suspending image capture commands to an optical system 1006, or maintaining a slide 1012 in a fixed position within a slide 1012 port while awaiting further action. In a non-limiting example, the pause may allow the processor 1002 to generate an alert, request operator 1044 input, or await confirmation of corrective action before resuming scanning operations. Without limitation, pausing the scan 1010 in response to defects identified at the macro-image stage improves imaging reliability by avoiding acquisition under conditions that are likely to produce unusable or misleading high-magnification image data and by conserving computational and mechanical resources of the system.

Still referring to FIG. 10, the at least a processor 1002 is configured to generate, as a function of the localization quality metric 1020 and the at least a second image 1026, a map 1038 comprising values associated with locations 1056 of the slide 1012 comprising a biological sample 1058. As used in this disclosure, “map” is a data structure that associates values with corresponding spatial locations 1056 of a slide 1012. In an embodiment, the slide 1012 may include a biological sample 1058. In an embodiment, the map 1038 may represent spatially indexed information derived from image data and one or more quality metrics. In a non-limiting example, the map 1038 may assign numerical or categorical values to coordinates that correspond to regions of the slide 1012. Without limitation, the map 1038 may be stored in memory 1004 as a matrix, grid, layered representation, or other spatially addressable format. In an embodiment, the map 1038 may appear as a two-dimensional representation aligned with the physical geometry of the slide 1012, where each location corresponds to a pixel region, tile, or coordinate space of the at least a second image 1026. In a non-limiting example, the map 1038 may visually resemble a heatmap, mask, or labeled overlay in which different values indicate tissue presence, defect 1034 likelihood, image quality, or region classification across the slide 1012. Without limitation, the map 1038 may be used by downstream software modules to guide high-magnification image acquisition 1036, selectively avoid low-quality regions, trigger remedial actions, support image stitching, enable inpainting, or provide spatial context to analytical or diagnostic algorithms, thereby improving efficiency, reliability, and interpretability of slide 1012 digitization workflows.

With continued reference to FIG. 10, the at least a processor 1002 may be further configured to detect a slide-quality control error 1040 and generate automated alerts 1042, wherein the automated alerts 1042 prompt an operator 1044 to undertake remedial action 1046. As used in this disclosure, “slide-quality control error” is a condition in which one or more characteristics of a slide 1012 or slide 1012 image fail to satisfy predetermined quality criteria required for reliable image acquisition or downstream analysis. In an embodiment, a slide-quality control error 1040 may correspond to physical, optical, or image-derived conditions associated with the slide 1012. In a non-limiting example, a slide-quality control error 1040 may indicate that acquired or anticipated image data do not meet acceptance thresholds. Without limitation, a slide-quality control error 1040 may be classified based on origin, severity, or impact on imaging performance. As used in this disclosure, “automated alerts” are system-generated notifications produced by at least a processor 1002 in response to detection of a defined condition requiring attention or intervention. In an embodiment, automated alerts 1042 may be generated without human initiation and in response to real-time analysis of image data or quality metrics. In a non-limiting example, automated alerts 1042 may be communicated through a user interface, visual indicator, audio signal, or electronic message. Without limitation, automated alerts 1042 may convey information identifying a detected condition and recommended next steps. As used in this disclosure, “operator” is a user authorized to interact with and control operation of a slide 1012 scanning system. Without limitation, the user may be a human or virtual agent. As used in this disclosure, “virtual agent” is a software-implemented entity configured to interact with, monitor, or control operation of a slide 1012 scanning system in a manner analogous to a human user. In an embodiment, the virtual agent may execute on one or more processors and may interface with system hardware and software through application programming interfaces or control modules. In a non-limiting example, the virtual agent may receive automated alerts 1042, evaluate system states, and initiate or authorize remedial actions based on predefined rules or learned decision models. Without limitation, the virtual agent may improve operation of the slide 1012 scanning system by enabling automated responses, reducing reliance on human intervention, and supporting continuous, scalable, and consistent system control. In an embodiment, the operator 1044 may include a technician, clinician, laboratory personnel, or other trained individual. In a non-limiting example, the operator 1044 may receive system feedback and provide input through a user interface. Without limitation, the operator 1044 may perform physical or procedural actions in response to system-generated information. As used in this disclosure, “remedial action” is an action undertaken to correct, mitigate, or respond to a detected condition that adversely affects image acquisition or quality. In an embodiment, remedial action 1046 may include procedural, mechanical, or computational responses. In a non-limiting example, remedial action 1046 may be selected based on the type or severity of a detected error. Without limitation, remedial action 1046 may restore the system to a state suitable for continued operation. In an embodiment, at least a processor 1002 may detect a slide-quality control error 1040 based on analysis of image data, quality metrics, or system state and may generate automated alerts 1042 that notify the operator 1044 of the detected condition. In a non-limiting example, the automated alerts 1042 may prompt the operator 1044 to undertake remedial action 1046 such as cleaning the slide 1012, adjusting mounting conditions, confirming slide 1012 placement, or authorizing a modified scanning workflow. Without limitation, this interaction between automated detection, alert generation, and operator-initiated remedial action 1046 improves slide 1012 digitization technology by reducing manual guesswork, preventing propagation of low-quality data, and enabling timely intervention before resources are expended on unsuccessful or unreliable imaging.

With continued reference to FIG. 10, the at least a processor 1002 may be further configured to classify, using a domain specific classifier 1048, preparation-domain defects 1050 from scanning-domain defects 1052 and determine an appropriate remediation workflow as a function of the classification. As used in this disclosure, “domain specific classifier” is a computational model configured to categorize detected conditions based on an origin domain associated with the conditions. In an embodiment, the domain specific classifier 1048 may operate on image data, extracted features, quality metrics, or system state information. In a non-limiting example, the domain specific classifier 1048 may be implemented using rule-based logic, machine learning models, or a combination thereof. Without limitation, the domain specific classifier 1048 may enable automated decision-making by distinguishing between conditions arising from different stages of a workflow. As used in this disclosure, “preparation-domain defect” is a defect 1034 originating from slide 1012 preparation, handling, or physical characteristics of a slide 1012 prior to image acquisition. In an embodiment, a preparation-domain defect 1050 may be inherent to the slide 1012 before it is introduced into a scanning system. In a non-limiting example, a preparation-domain defect 1050 may persist regardless of scanning parameters or imaging adjustments. Without limitation, a preparation-domain defect 1050 may require off-system intervention to correct. As used in this disclosure, “scanning-domain defect” is a defect 1034 originating from image acquisition processes or operational conditions of a slide 1012 scanning system. In an embodiment, a scanning-domain defect 1052 may arise during optical imaging, mechanical motion, or illumination control. In a non-limiting example, a scanning-domain defect 1052 may be influenced by adjustable scanning parameters. Without limitation, a scanning-domain defect 1052 may be correctable through on-system actions. As used in this disclosure, “appropriate remedial workflow” is a sequence of actions selected based on classification of a detected defect 1034 and configured to address the defect 1034 in an effective manner. In an embodiment, the appropriate remedial workflow 1054 may differ depending on whether the defect 1034 is classified as preparation-domain or scanning-domain. In a non-limiting example, the appropriate remedial workflow 1054 may include automated actions, operator prompts, or system pauses. Without limitation, the appropriate remedial workflow 1054 may minimize resource usage while restoring conditions suitable for imaging. In an embodiment, at least a processor 1002 may classify detected defects using the domain specific classifier 1048 by analyzing image features, quality metrics, or system conditions to determine whether the defects originate from slide 1012 preparation or from scanning operations. In a non-limiting example, when a defect 1034 is classified as a preparation-domain defect 1050, the processor 1002 may determine an appropriate remedial workflow 1054 that includes halting the scan 1010 and prompting off-system intervention, while classification as a scanning-domain defect 1052 may result in automated parameter adjustment or selective reacquisition. Without limitation, this classification-driven selection of remedial workflows improves imaging technology by ensuring that corrective actions are matched to defect 1034 origin, reducing unnecessary rescans, increasing system efficiency, and improving reliability of slide 1012 digitization outcomes.

With continued reference to FIG. 10, the at least a processor 1002 may be further configured to detect an annotation 1060 on the slide 1012, determine, using the domain specific classifier 1048, the annotation 1060 is a preparation-domain defect 1050, and determine the appropriate remediation workflow as a function of the classification. As used in this disclosure, “annotation” is a marking, symbol, or indicium present on a slide 1012 that is not part of a biological sample 1058. In an embodiment, an annotation 1060 may be applied intentionally or unintentionally during handling or preparation of the slide 1012. In a non-limiting example, an annotation 1060 may be located on a glass surface, a coverslip, or an edge region of the slide 1012. Without limitation, an annotation 1060 may visually interfere with optical imaging or downstream analysis. In an embodiment, a preparation-domain defect 1050 may be introduced before the slide 1012 is placed into a scanning system. In a non-limiting example, a preparation-domain defect 1050 may remain present regardless of scanning parameter adjustments. Without limitation, a preparation-domain defect 1050 may require corrective action outside of the scanning process. In an embodiment, at least a processor 1002 may be configured to detect an annotation 1060 on the slide 1012 by analyzing image data captured by the optical system 1006 and identifying visual features inconsistent with biological tissue. In a non-limiting example, the processor 1002 may determine, using the domain specific classifier 1048, that the annotation 1060 is a preparation-domain defect 1050 based on its appearance, location, or lack of correspondence to specimen morphology. Without limitation, the processor 1002 may then determine an appropriate remediation workflow as a function of the classification, such as pausing the scan 1010, generating an automated alert, or prompting an operator 1044 or virtual agent to perform corrective action before imaging proceeds, thereby preventing propagation of annotation-related artifacts into high-magnification image data.

With continued reference to FIG. 10, the at least a processor 1002 may be further configured to detect tissue located outside a coverslip area 1062 of the slide 1012, determine, using the domain specific classifier 1048, the detected tissue is a preparation-domain defect 1050, and determine the appropriate remediation workflow as a function of the classification. As used in this disclosure, “coverslip area” is a region of a slide 1012 corresponding to a spatial footprint of a coverslip disposed over a biological sample 1058. In an embodiment, the coverslip area 1062 may define an optically protected region intended for high-magnification image acquisition 1036. In a non-limiting example, the coverslip area 1062 may be determined based on detected boundaries, geometry, or known placement characteristics of the coverslip. Without limitation, the coverslip area 1062 may be used as a reference region for assessing slide 1012 preparation quality. As used in this disclosure, “coverslip” is a substantially transparent sheet positioned over a biological sample 1058 on a slide 1012 to protect the sample and provide an optically uniform interface for imaging. In an embodiment, the coverslip may be secured to the slide 1012 using a mounting medium to maintain sample position and surface planarity. In a non-limiting example, the coverslip may define a controlled optical path between the sample and an objective of an optical system 1006. Without limitation, the coverslip may facilitate consistent focus, reduce contamination, and support reliable high-magnification image acquisition 1036. In an embodiment, at least a processor 1002 may detect tissue located outside the coverslip area 1062 by analyzing a macro image 1028 and identifying biological material extending beyond the detected boundaries of the coverslip. In a non-limiting example, the processor 1002 may determine, using the domain specific classifier 1048, that the detected tissue outside the coverslip area 1062 constitutes a preparation-domain defect 1050 because the tissue is not positioned within an optically stable and protected region suitable for imaging. Without limitation, the processor 1002 may then determine an appropriate remediation workflow as a function of the classification, such as pausing the scan 1010 and prompting an operator 1044 or virtual agent to remount the tissue or prepare a new slide 1012, thereby preventing focus instability, optical artifacts, or mechanical interference during high-magnification image acquisition 1036.

With continued reference to FIG. 10, the at least a processor 1002 may be further configured to identify, using a fiduciary-marker recognition module 1064, one or more reference markers 1066 present on the slide 1012, wherein the one or more reference markers 1066 establish coordinate anchors 1068 across imaging sessions. As used in this disclosure, “fiduciary-marker recognition module” is a software or hardware component configured to detect and identify fiduciary markers present on a slide 1012. In an embodiment, the fiduciary-marker recognition module 1064 may operate on image data captured by an optical system 1006. In a non-limiting example, the fiduciary-marker recognition module 1064 may use pattern recognition, image-processing techniques, or machine learning models. Without limitation, the fiduciary-marker recognition module 1064 may output positional information associated with detected markers. In an embodiment, the fiduciary-marker recognition module 1064 may be trained using supervised machine learning in which labeled training data associate image inputs with known fiduciary-marker locations, identities, and orientations. In a non-limiting example, the training data may include macro images, low-magnification images, or high-magnification image patches of slides containing fiduciary markers captured under varied lighting conditions, orientations, scanner models, and slide 1012 types to promote robustness. Without limitation, the training data may include annotations specifying marker boundaries, centroids, orientation vectors, and expected coordinate relationships, as well as negative examples that contain slide 1012 markings or biological structures that are not fiduciary markers. In an embodiment, the fiduciary-marker recognition module 1064 may employ artificial intelligence or machine learning models configured for visual pattern recognition. In a non-limiting example, the model may include a convolutional neural network trained to detect spatial patterns, edges, and contrast signatures characteristic of fiduciary markers. Without limitation, alternative or complementary models may include transformer-based vision models, classical feature-based classifiers using keypoint descriptors, or hybrid systems that combine learned representations with rule-based geometric validation. In an embodiment, training may further include data augmentation techniques that synthetically vary scale, rotation, brightness, noise, and partial occlusion of fiduciary markers to simulate real-world scanning variability. In a non-limiting example, synthetic training images may be generated using procedural rendering or simulation tools to create fiduciary markers with controlled geometries and placements. Without limitation, such training approaches improve imaging technology by enabling the fiduciary-marker recognition module 1064 to generalize across scanners, slide 1012 formats, and imaging sessions, thereby supporting reliable coordinate anchoring and spatial consistency in automated slide 1012 digitization workflows. As used in this disclosure, “reference markers” are physical or visual indicia disposed on a slide 1012 that are distinct from biological sample 1058 features and configured to be detectable by an imaging system. In an embodiment, reference markers 1066 may include printed, etched, embedded, or applied features. In a non-limiting example, reference markers 1066 may have predefined shapes, contrasts, or spatial arrangements. Without limitation, reference markers 1066 may be used to support spatial alignment and orientation. As used in this disclosure, “coordinate anchor” is a defined spatial reference point used to establish or maintain consistency of a coordinate system. In an embodiment, a coordinate anchor 1068 may correspond to a detected reference marker. In a non-limiting example, a coordinate anchor 1068 may be used to align image data with physical slide 1012 geometry. Without limitation, a coordinate anchor 1068 may support spatial registration across datasets. As used in this disclosure, “imaging session” is a period during which image data of a slide 1012 are acquired by an imaging system under defined operational conditions. In an embodiment, an imaging session may include a single scan 1010 or multiple related scans. In a non-limiting example, an imaging session may occur at a different time or on a different system than a prior session. Without limitation, an imaging session may generate image data intended to be spatially comparable to image data from other sessions. In an embodiment, at least a processor 1002 may identify one or more reference markers 1066 present on the slide 1012 using the fiduciary-marker recognition module 1064 by analyzing image data and detecting marker-specific features. In a non-limiting example, the identified reference markers 1066 may establish coordinate anchors 1068 that define a consistent spatial framework for the slide 1012, enabling alignment of image data across multiple imaging sessions. Without limitation, maintaining coordinate anchors 1068 across imaging sessions improves imaging technology by supporting repeatable scan 1010 planning, accurate spatial registration, and reliable comparison of image data acquired at different times or using different imaging systems.

With continued reference to FIG. 10, the at least a processor 1002 may be further configured to detect reversed fiduciary-marker orientation 1070 by analyzing slide markings 1072. As used in this disclosure, “reversed fiduciary-marker orientation” is a condition in which one or more fiduciary markers on a slide are oriented in an inverted or opposite spatial relationship relative to an expected reference orientation. In an embodiment, reversed fiduciary-marker orientation 1070 may indicate that a slide is positioned incorrectly within a scanning system. In a non-limiting example, reversed fiduciary-marker orientation 1070 may correspond to a rotation or inversion of the slide relative to a predefined coordinate system. Without limitation, reversed fiduciary-marker orientation 1070 may disrupt spatial alignment and image registration. As used in this disclosure, “slide markings” are visible features, symbols, or indicia present on a slide 1012 that provide orientation, identification, or reference information. In an embodiment, slide markings 1072 may be applied during manufacturing, labeling, or preparation of the slide 1012. In a non-limiting example, slide markings 1072 may include printed text, etched symbols, or alignment indicators. Without limitation, slide markings 1072 may be distinguishable from biological sample 1058 features in image data. In an embodiment, at least a processor 1002 may detect reversed fiduciary-marker orientation 1070 by analyzing slide markings 1072 captured in image data and comparing their spatial arrangement to an expected orientation model. In a non-limiting example, the processor 1002 may evaluate relative positions, directional features, or geometric relationships of the slide markings 1072 to determine whether the fiduciary markers are inverted or reversed. In a non-limiting example, the processor 1002 may evaluate relative positions, directional features, or geometric relationships of the slide markings 1072 using image-processing and machine-learning techniques implemented in software executing on one or more processors. In an embodiment, the processor 1002 may apply edge-detection, corner-detection, or keypoint-extraction algorithms to identify salient features of the slide markings 1072 and compute orientation vectors that describe their directional alignment within the image. Without limitation, the processor 1002 may compare these computed vectors against stored reference templates or expected coordinate models to determine whether the fiduciary markers exhibit inversion, rotation, or mirroring relative to a known orientation. In a non-limiting example, the processor 1002 may employ a trained machine learning model such as a convolutional neural network or a vision transformer to infer marker orientation directly from image data by learning spatial patterns associated with correct and reversed configurations. In an embodiment, the model may output an orientation classification or confidence score indicating whether the detected fiduciary markers are aligned or reversed. Without limitation, the processor 1002 may further validate the determination using geometric consistency checks, such as evaluating inter-marker distances, angular relationships, or symmetry constraints, thereby improving robustness and reducing false determinations in automated slide 1012 orientation detection. Without limitation, detection of reversed fiduciary-marker orientation 1070 enables the system to prevent misregistration, correct coordinate interpretation, or initiate a remediation workflow that ensures consistent spatial alignment before high-magnification image acquisition 1036 proceeds.

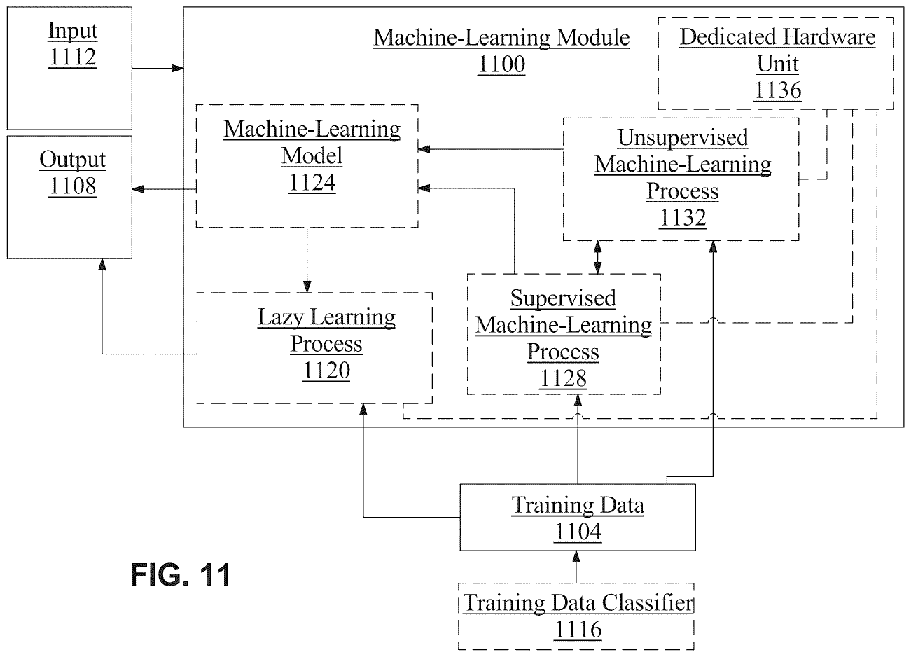

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm instantiated in hardware or software logic, data structures, and/or functions that will be performed by a computing device/module to produce outputs 1108 given data provided as inputs 1112; this is in contrast to a non-machine learning software program where the commands to be executed are determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure. As a non-limiting illustrative example, inputs may include image data and outputs may include text data.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1100 may generate a classifier using a classification algorithm, defined as a processes whereby a computing device and/or any module and/or component operating thereon derives a classifier from training data 1104. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1116 may classify elements of training data to individual glyphs as in an OCR machine learning model.

With further reference to FIG. 11, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 11, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 11, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 11, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 11, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 11, machine-learning module 1100 may be configured to perform a lazy-learning process 1120 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1124 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include image data as described above as inputs, classification to particular characters as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

With further reference to FIG. 11, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 11, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1132 may not require a response variable; unsupervised processes 1132 may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 11, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 11, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 11, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 11, one or more processes or algorithms described above may be performed by at least a dedicated hardware unit 1136. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1136 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1136 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1136 to perform one or more operations described herein, such as evaluation of model and/or algorithm outputs, one-time or iterative updates to parameters, coefficients, weights, and/or biases, and/or any other operations such as vector and/or matrix operations as described in this disclosure.

With continued reference to FIG. 11, system 100 may use user feedback to train the machine-learning models and/or classifiers described above. For example, classifier may be trained using past inputs and outputs of classifier. In some embodiments, if user feedback indicates that an output of classifier was “bad,” then that output and the corresponding input may be removed from training data used to train classifier, and/or may be replaced with a value entered by, e.g., another user that represents an ideal output given the input the classifier originally received, permitting use in retraining, and adding to training data; in either case, classifier may be retrained with modified training data as described in further detail below. In some embodiments, training data of classifier may include user feedback.

With continued reference to FIG. 11, in some embodiments, an accuracy score may be calculated for classifier using user feedback. For the purposes of this disclosure, “accuracy score,” is a numerical value concerning the accuracy of a machine-learning model. For example, a plurality of user feedback scores may be averaged to determine an accuracy score. In some embodiments, a cohort accuracy score may be determined for particular cohorts of persons. For example, user feedback for users belonging to a particular cohort of persons may be averaged together to determine the cohort accuracy score for that particular cohort of persons and used as described above. Accuracy score or another score as described above may indicate a degree of retraining needed for a machine-learning model such as a classifier; system 100 may perform a larger number of retraining cycles for a higher number (or lower number, depending on a numerical interpretation used), and/or may collect more training data for such retraining, perform more training cycles, apply a more stringent convergence test such as a test requiring a lower mean squared error, and/or indicate to a user and/or operator that additional training data is needed.

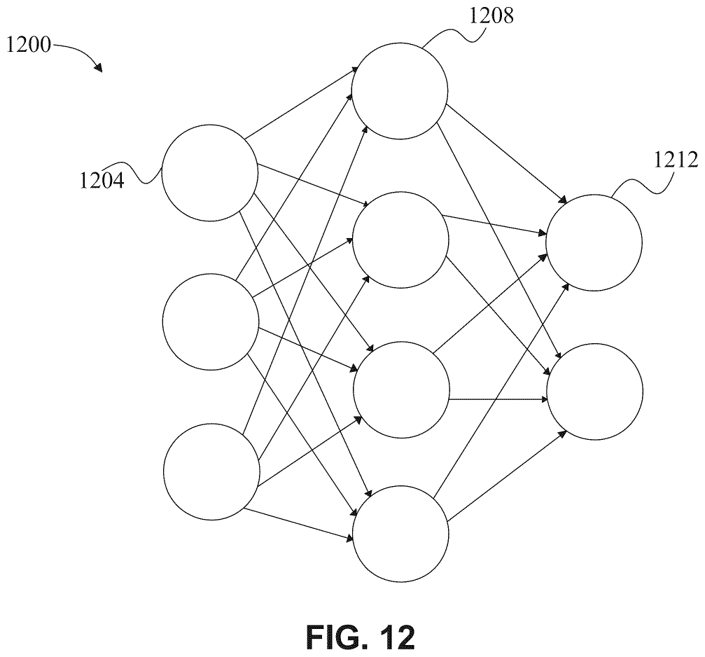

Referring now to FIG. 12, an exemplary embodiment of neural network 1200 is illustrated. A neural network 1200 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1204, one or more intermediate layers 1208, and an output layer of nodes 1212. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

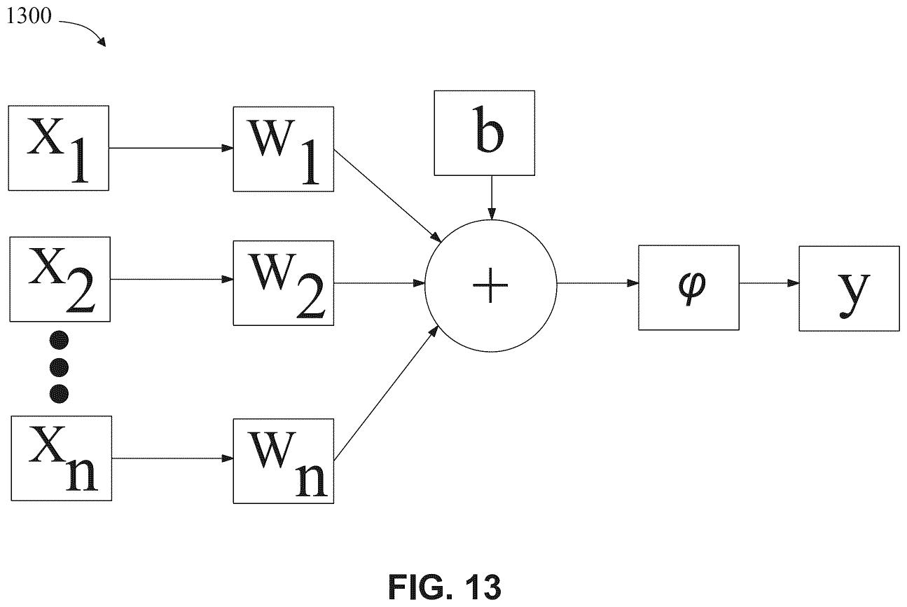

Referring now to FIG. 13, an exemplary embodiment of a node 1300 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh² (x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid (x), a Gaussian error linear unit function such as f(x)=α(1+tanh (\sqrt{2/π} (x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Still referring to FIG. 13, a “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. CNN may include, without limitation, a deep neural network (DNN) extension, where a DNN is defined as a neural network with two or more hidden layers.

Still referring to FIG. 13, in some embodiments, a convolutional neural network may learn from images. In non-limiting examples, a convolutional neural network may perform tasks such as classifying images, detecting objects depicted in an image, segmenting an image, and/or processing an image. In some embodiments, a convolutional neural network may operate such that each node in an input layer is only connected to a region of nodes in a hidden layer. In some embodiments, the regions in aggregate may create a feature map from an input layer to the hidden layer. In some embodiments, a convolutional neural network may include a layer in which the weights and biases for all nodes are the same. In some embodiments, this may allow a convolutional neural network to detect a feature, such as an edge, across different locations in an image.

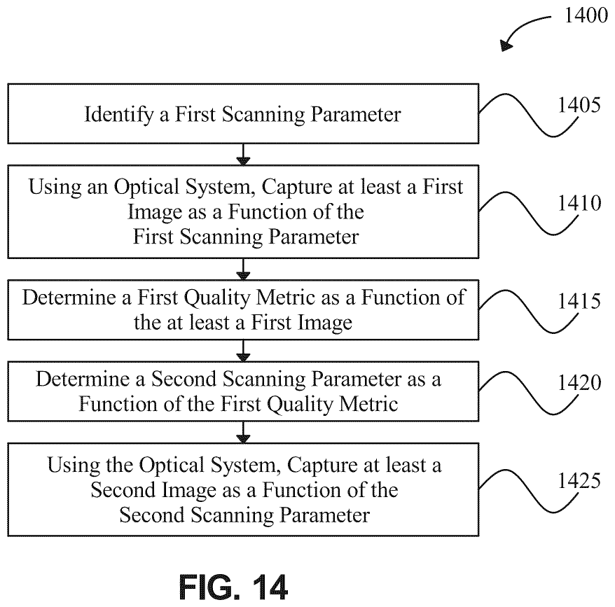

Referring now to FIG. 14, an exemplary embodiment of a method 1400 of digitizing a slide is illustrated. One or more steps if method 1400 may be implemented, without limitation, as described with reference to other figures. One or more steps of method 1400 may be implemented, without limitation, using at least a processor. Method 1400 may include performing a scan of a slide by capturing at least a first image and capturing at least a second image.

Still referring to FIG. 14, in some embodiments, performing a scan of a slide may include identifying a first scanning parameter 1405.

Still referring to FIG. 14, in some embodiments, performing a scan of a slide may include using an optical system, capturing the at least a first image as a function of the first scanning parameter 1410.

Still referring to FIG. 14, in some embodiments, performing a scan of a slide may include determining a first quality metric as a function of the at least a first image 1415. In some embodiments, the first quality metric includes a localization quality metric; and determining the second scanning parameter includes identifying at least a region of interest of the slide. In some embodiments, the first quality metric includes a biopsy plane estimation quality metric; and determining the second scanning parameter includes identifying a plane within a region of interest which contains a biological specimen. In some embodiments, the first quality metric includes a focus sampling quality metric; and determining the second scanning parameter includes identifying a focal setting at which a selected point is in focus. In some embodiments, the first quality metric includes a z-stack acquisition quality metric; and determining the second scanning parameter includes, using the optical system, capturing a z-stack at a selected point.

Still referring to FIG. 14, in some embodiments, performing a scan of a slide may include determining a second scanning parameter as a function of the first quality metric 1420.

Still referring to FIG. 14, in some embodiments, performing a scan of a slide may include using the optical system, capturing the at least a second image as a function of the second scanning parameter 1425. In some embodiments, the at least a first image includes a macro image; and capturing the at least a second image includes, using the optical system, capturing a first plurality of images; and combining the first plurality of images to create the at least a second image.

Still referring to FIG. 14, in some embodiments, performing the scan further includes determining a stitching quality metric as a function of the at least a second image; determining a third scanning parameter as a function of the stitching quality metric; using the optical system, capturing a second plurality of images as a function of the third scanning parameter; and combining the second plurality of images to create at least a third image. In some embodiments, performing the scan further includes capturing the at least a first image at a first location and capturing the at least a second image at a second location. In some embodiments, performing the scan further comprises determining a second quality metric as a function of the at least a first image; determining a combination quality metric as a function of the first quality metric and the second quality metric; determining a third scanning parameter as a function of the combination quality metric; and using the optical system, capturing at least a third image as a function of the second scanning parameter. In some embodiments, performing the scan further includes algorithmically removing a banding error from the at least a second image. In some embodiments, upon detection of a banding error and/or banding errors of sufficient severity, a remedial action may be taken. Remedial actions may include, in non-limiting examples, pausing a scanner, triggering a cleaning mechanism in order to remove and/or reduce banding errors, and/or switching to alternative optical components.

In some embodiments, one or more aspects of a system described herein may be implemented as described in U.S. patent application Ser. No. 18/384,840 (having attorney docket number 1519-103USU1), filed on Oct. 28, 2023, and titled “APPARATUS AND METHODS FOR SLIDE IMAGING,” the entirety of which is hereby incorporated by reference. For example, localization module, biopsy plane estimation module, focus sampling module, z-stack acquisition module, stitching module, and/or whole slide assessment module may be implemented as described in the incorporated patent application.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

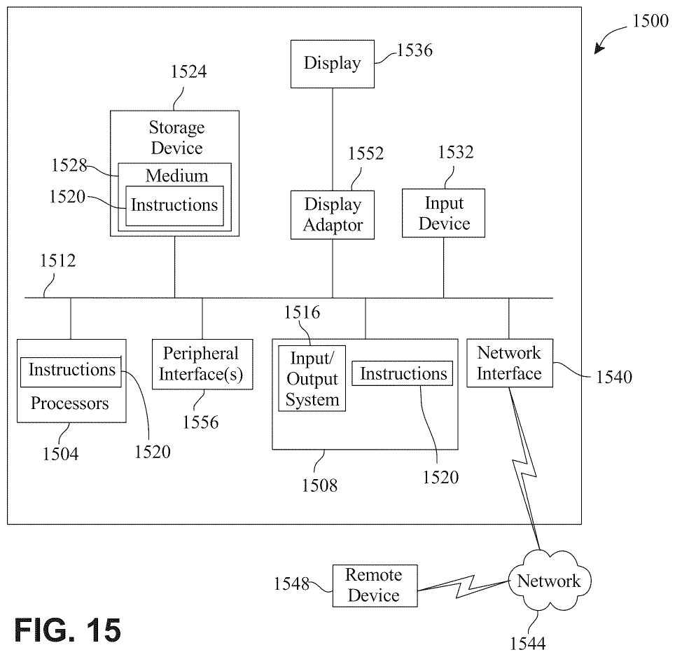

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for digitizing a slide, wherein the system comprises:
an optical system comprising at least an optical sensor; and
at least a processor communicatively connected to the optical system, wherein the at least a processor is configured to:
perform a scan of a slide by capturing at least a first image according to a first scanning parameter;
determine, using a localization module, a localization quality metric as a function of the at least a first image;
identify, using the localization module and the localization quality metric, at least one region of interest of the slide;
determine a second scanning parameter as a function of the localization quality metric;
capture, using the optical system, at least a second image of the slide according to the second scanning parameter; and
generate, as a function of the localization quality metric and the at least a second image, a map comprising values associated with locations of the slide comprising a biological sample.

2. The system of claim 1, wherein:
the at least a first image comprises a macro image; and
capturing the at least a second image comprises:
using the optical system, capturing a first plurality of images; and
combining the first plurality of images to create the at least a second image.

3. The system of claim 2, wherein the at least a processor is further configured to perform a pre-scan determination, wherein the determination comprises an identification of one or more defects within the macro image, wherein the one or more defects prevent successful high-magnification image acquisition.

4. The system of claim 2, wherein the at least a processor is further configured to pause the scan when the one or more defects are identified within the macro image.

5. The system of claim 1, wherein the at least a processor is further configured to:
detect a slide-quality control error; and
generate automated alerts, wherein the automated alerts prompt an operator to undertake remedial action.

6. The system of claim 1, wherein the at least a processor is further configured to:
classify, using a domain specific classifier, preparation-domain defects from scanning-domain defects; and
determine an appropriate remediation workflow as a function of the classification.

7. The system of claim 6, wherein the at least a processor is further configured to:
detect an annotation on the slide;
determine, using the domain specific classifier, the annotation is a preparation-domain defect; and
determine the appropriate remediation workflow as a function of the classification.

8. The system of claim 6, wherein the at least a processor is further configured to:
detect tissue located outside a coverslip area of the slide,
determine, using the domain specific classifier, the detected tissue is a preparation-domain defect; and
determine the appropriate remediation workflow as a function of the classification.

9. The system of claim 1, wherein the at least a processor is further configured to identify, using a fiduciary-marker recognition module, one or more reference markers present on the slide, wherein the one or more reference markers establish coordinate anchors across imaging sessions.

10. The system of claim 1, wherein the at least a processor is further configured to detect reversed fiduciary-marker orientation by analyzing slide markings.

11. A method of digitizing a slide, wherein the method comprises:
performing, using an optical system comprising at least an optical sensor, a scan of a slide by capturing a first image according to a first scanning parameter;
determining, using a localization module, a localization quality metric as a function of the first image;
identifying, using the localization module and the localization quality metric, at least one region of interest of the slide;
determining, using at least a processor communicatively connected to the optical system, a second scanning parameter as a function of the localization quality metric;
capturing, using the optical system, at least a second image of the slide according to the second scanning parameter; and
generating, as a function of the localization quality metric and the at least a second image, a map comprising values associated with locations of the slide comprising a biological sample.

12. The method of claim 11, wherein:
the at least a first image comprises a macro image; and
capturing the at least a second image comprises:
using the optical system, capturing a first plurality of images; and
combining the first plurality of images to create the at least a second image.

13. The method of claim 12, further comprising performing, using the at least a processor, a pre-scan determination, wherein the determination comprises an identification of one or more defects within the macro image, wherein the one or more defect prevents successful high-magnification image acquisition.

14. The method of claim 12, further comprising pausing, using the at least a processor, the scan when the identification of the one or more defects is present within the macro image.

15. The method of claim 11, further comprising:
detecting, using the at least a processor, a slide-quality control error; and
generating, using the at least a processor, automated alerts, wherein the automated alerts prompt an operator to undertake remedial action.

16. The method of claim 11, further comprising:
classifying, using a domain specific classifier, preparation-domain defects from scanning-domain defects; and
determining, using the at least a processor, an appropriate remediation workflow as a function of the classification.

17. The method of claim 16, further comprising:
detecting, using the at least a processor, an annotation on the slide;
determining, using the domain specific classifier, the annotation is a preparation-domain defect; and
determine the appropriate remediation workflow as a function of the classification.

18. The method of claim 16, further comprising:
detecting, using the at least a processor, tissue located outside a coverslip area of the slide,
determining, using the domain specific classifier, the detected tissue is a preparation-domain defect; and
determining, using the at least a processor, the appropriate remediation workflow as a function of the classification.

19. The method of claim 11, further comprising identifying, using a fiduciary-marker recognition module, one or more reference markers present on the slide, wherein the one or more reference markers establish coordinate anchors across imaging sessions.

20. The method of claim 11, further comprising detecting, using the at least a processor, reversed fiduciary-marker orientation by analyzing slide markings.
